(19) United States
(12) Patent Application Publication
(10) Pub. No.: US 2023/0097289 A1
(43) Pub. Date: Mar. 30, 2023

(54) SENSORS FOR ANTIMICROBIAL BIPHASIC POLYMERS, AND SYSTEMS AND METHODS INCORPORATING THE SAME

(71) Applicant: HRL Laboratories, LLC, Malibu, CA (US)

(72) Inventors: John VAJO, West Hills, CA (US); Adam GROSS, Santa Monica, CA (US); Jason GRAETZ, Calabasas, CA (US)

(21) Appl. No.: 18/074,988

(22) Filed: Dec. 5, 2022

Related U.S. Application Data
(63) Continuation-in-part of application No. 17/564,903, filed on Dec. 29, 2021.
Application No. 17/564,903 is a continuation of application No. 16/876,075, filed on May 17, 2020, now Pat. No. 11,225,589.
Application No. 16/876,075 is a division of application No. 15/957,638, filed on Apr. 19, 2018, now Pat. No. 10,689,542.
Application No. 15/957,638 is a continuation-in-part of application No. 17/713,356, filed on Apr. 5, 2022.
Application No. 17/713,356 is a continuation of application No. 17/090,968, filed on Nov. 6, 2020, now Pat. No. 11,369,109.
Application No. 17/090,968 is a continuation-in-part of application No. 17/852,307, filed on Jun. 28, 2022.
Application No. 17/852,307 is a continuation-in-part of application No. 17/713,356, filed on Apr. 5, 2022.
Application No. 17/713,356 is a continuation of application No. 17/090,968, filed on Nov. 6, 2020, now Pat. No. 11,369,109.
(60) Provisional application No. 63/305,445, filed on Feb. 1, 2022.
(60) Provisional application No. 62/543,590, filed on Aug. 10, 2017.
(60) Provisional application No. 62/607,402, filed on Dec. 19, 2017.
(60) Provisional application No. 62/634,990, filed on Feb. 26, 2018.
(60) Provisional application No. 63/037,921, filed on Jun. 11, 2020.
(60) Provisional application No. 63/236,311, filed on Aug. 24, 2021.
(60) Provisional application No. 63/037,921, filed on Jun. 11, 2020.

(51) Int. Cl. C09D 171/02; C08G 65/00; C08L 101/02; C09D 201/02; C08G 65/22; C08G 81/00

(52) U.S. Cl. CPC C09D 171/02; C08G 65/007; C08L 101/02; C09D 201/02; C08G 65/226; C08G 81/00; C08G 2650/22; C08G 2650/48; C08G 2650/58

(57) ABSTRACT

Some variations provide a sensing system configured to measure the concentration of an antimicrobial agent in a polymer, comprising: a polymer containing (i) a discrete solid structural phase comprising a solid structural polymer and (ii) a continuous transport phase comprising a solid transport polymer and capable of containing the antimicrobial agent; and an antimicrobial-agent sensor that chemically senses the antimicrobial agent. The antimicrobial-agent sensor is disposed on a surface of, and in mass transport with, the polymer. The antimicrobial-agent sensor contains a responsive material disposed on or within a carrier material. The responsive material is chemically reactive with the antimicrobial agent and exhibits an observable and quantifiable property change upon chemically reacting with the antimicrobial agent. The observable and quantifiable property change may involve chromaticity, optical transparency, ionic conductivity, or electronic conductivity, for example. Some variations provide methods of making and/or using the sensing system.

### PRIORITY DATA

This patent application claims priority to U.S. Provisional Patent App. No. 63/305,445, filed on Feb. 1, 2022, which is hereby incorporated by reference herein.

This patent application is also a continuation-in-part application of U.S. patent application Ser. No. 17/564,903, filed on Dec. 29, 2021, which is a continuation application of U.S. Pat. No. 11,225,589, issued on Jan. 18, 2022, which is a divisional of U.S. Pat. No. 10,689,542, issued on Jun. 23, 2020, which in turn claims priority to (a) U.S. Provisional Patent App. No. 62/543,590, filed on Aug. 10, 2017; (b) U.S. Provisional Patent App. No. 62/607,402, filed on Dec. 19, 2017; and (c) U.S. Provisional Patent App. No. 62/634,990, filed on Feb. 26, 2018, each of which is hereby incorporated by reference herein.

This patent application is also a continuation-in-part application of U.S. patent application Ser. No. 17/713,356, filed on Apr. 5, 2022, which is a continuation application of U.S. Pat. No. 11,369,109, issued on Jun. 28, 2022, which is a non-provisional application claiming priority to U.S. Provisional Patent App. No. 63/037,921, filed on Jun. 11, 2020, each of which is hereby incorporated by reference herein.

This patent application is also a continuation-in-part application of U.S. patent application Ser. No. 17/852,307, filed on Jun. 28, 2022, which is a non-provisional application claiming priority to U.S. Provisional Patent App. No. 63/236,311, filed on Aug. 24, 2021, each of which is hereby incorporated by reference herein. U.S. patent application Ser. No. 17/852,307 is also a continuation-in-part application of U.S. patent application Ser. No. 17/713,356, filed on Apr. 5, 2022, which is a continuation application of U.S. Pat. No. 11,369,109, issued on Jun. 28, 2022, which is a non-provisional application claiming priority to U.S. Provisional Patent App. No. 63/037,921, filed on Jun. 11, 2020, each of which is hereby incorporated by reference herein.

### FIELD OF THE INVENTION

The present invention generally relates to sensing systems for antimicrobial agents contained in biphasic polymers.

### BACKGROUND OF THE INVENTION

Coronavirus disease 2019 (“COVID-19”) is caused by severe acute respiratory syndrome coronavirus 2 (“SARS-CoV-2”). The COVID-19 pandemic emphasized the importance of environmental cleanliness and hygiene management involving a wide variety of surfaces. Despite the strict hygiene measures which have been enforced, it has proven to be very difficult to sanitize surfaces all of the time. Even when sanitized, surfaces may get contaminated again.

Respiratory secretions or droplets expelled by infected individuals can contaminate surfaces and objects, creating fomites (contaminated surfaces). Viable SARS-CoV-2 virus can be found on contaminated surfaces for periods ranging from hours to many days, depending on the ambient environment (including temperature and humidity) and the type of surface. See, for example, Van Doremalen et al., “Aerosol and surface stability of SARS-CoV-2 as compared with SARS-CoV-1”, New England Journal of Medicine 2020; 382: 1564-1567; Pastorino et al., “Prolonged Infectivity of SARS-CoV-2 in Fomites”, Emerging Infectious Diseases 2020; 26(9); and Chin et al., “Stability of SARS-CoV-2 in different environmental conditions”, The Lancet Microbe, e10, Apr. 2, 2020.

There is consistent evidence of SARS-CoV-2 contamination of surfaces and the survival of the virus on certain surfaces. People who come into contact with potentially infectious surfaces often also have close contact with the infectious person, making the distinction between respiratory droplet and fomite transmission difficult to discern. However, fomite transmission is considered a feasible mode of transmission for SARS-CoV-2, given consistent findings about environmental contamination in the vicinity of infected cases and the fact that other coronaviruses and respiratory viruses can transmit this way (World Health Organization, “Transmission of SARS-CoV-2: implications for infection prevention precautions”, Jul. 9, 2020 via www.who.int). Virus transmission may also occur indirectly through touching surfaces in the immediate environment or objects contaminated with virus from an infected person, followed by touching the mouth, nose, or eyes. While use of face masks has, generally speaking, become relatively common, use of hand gloves has not. Even with gloves, touching of mouth, nose, and eyes still frequently occurs, following the touch of a contaminated surface.

Monkeypox is a rare disease caused by the monkeypox virus. Monkeypox virus is an enveloped virus that belongs to the Orthopoxvirus genus of the Poxviridae family. It is possible to become infected by the monkeypox virus after touching a surface that has been used by someone with monkeypox. Monkeypox is regarded as the most significant Orthopoxvirus infection affecting humans since the eradication of smallpox.

There is a strong desire to prevent the transmission of pathogens (such as, but not limited to, SARS-CoV-2 or monkeypox virus) via surfaces. One method of reducing pathogen transmission is to reduce the period of human vulnerability to infection by reducing the period of viability of SARS-CoV-2 or monkeypox virus on solids and surfaces.

Surfaces may be treated with antimicrobial actives, such as bleach and quaternary ammoniums salts, or UV light, to kill bacteria and destroy viruses within a matter of minutes. Antimicrobial actives in liquids are capable of inactivating at least 99.99% of SARS-CoV-2 in as little as 2 minutes, which is attributed to the rapid diffusion of the antimicrobial active to microbes and because water aids microbial dismemberment. However, these approaches cannot always occur in real-time after a surface is contaminated.

Alternatively, antimicrobial coatings may be applied to a surface in order to kill bacteria and/or destroy viruses as they deposit. However, to exceed 99.9% reduction of bacteria and/or viruses, conventional antimicrobial coatings typically require at least 2 hours, a time scale which is longer than indirect human-to-human interaction time, such as in an aircraft or shared vehicle, for example. Existing solid coatings are limited by a low concentration of antimicrobial actives at the surface due to slow antimicrobial active transport. The slow diffusion of antimicrobial actives through the solid coating to the surface, competing with the removal of antimicrobial actives from the surface by human and environmental contact, results in limited availability and requires up to 2 hours to kill 99.9% of bacteria and/or deactivate 99.9% of viruses.

Water improves transport and aids microbial dismemberment. However, single-material coatings have limited water uptake. Swelling with water is often an unwanted characteristic of single-material coatings, since swelling can cause coating weakness and degradation if not designed into the coating.

In view of the aforementioned needs in the art, there is a strong desire for an antimicrobial coating that enables fast transport rates of antimicrobial actives for better effectiveness on deactivating SARS-CoV-2, monkeypox virus, or other pathogens on surfaces. The coating should be safe, conveniently applied or fabricated, and durable. It is particularly desirable for such a coating to be capable of destroying at least 99%, preferably at least 99.9%, and more preferably at least 99.99% of bacteria and/or viruses in 30 minutes of contact.

Improved antimicrobial coatings, including transparent antimicrobial coatings and/or antifouling antimicrobial coatings, are still desired. For example, methods are desired to conveniently measure the concentration of antimicrobial actives in biphasic polymers.

### SUMMARY OF THE INVENTION

Some variations of the invention provide a sensing system configured to measure the concentration of an antimicrobial agent in a polymer, the system comprising:

(a) a polymer containing (i) a discrete solid structural phase comprising a solid structural polymer and (ii) a continuous transport phase comprising a solid transport polymer, wherein the continuous transport phase is capable of containing the antimicrobial agent; and

(b) an antimicrobial-agent sensor that chemically senses the antimicrobial agent, wherein the antimicrobial-agent sensor is disposed on a surface of, and in mass transport with, the polymer,

wherein the antimicrobial-agent sensor contains a responsive material disposed on or within a carrier material,

wherein the responsive material is chemically reactive with the antimicrobial agent, and

wherein the responsive material exhibits an observable and quantifiable property change upon chemically reacting with the antimicrobial agent.

In some embodiments, the carrier material is a solid, such as a solid sheet. The solid sheet may be selected from the group consisting of a paper sheet, a plastic sheet, a metal or metal alloy sheet, a metal oxide sheet, a carbon sheet, and combinations thereof. The geometry of a “sheet” may vary, such as a square, a rectangle, or a circle, and may also be referred to as a strip, a pad, or a tab, for example. Also, the porosity of the carrier material may vary, from slightly porous to highly porous.

In some embodiments, a side of a solid sheet is completely covered by the responsive material. In other embodiments, a side of a solid sheet is partially covered by the responsive material. For example, the responsive material may be printed on the solid sheet in the form of a letter, a symbol, or a word.

In some embodiments, a solid sheet is at least partially coated with an adhesive to attach the antimicrobial-agent sensor to the polymer. The adhesive may be disposed onto a portion of the solid sheet, such as the perimeter of the solid sheet. Alternatively, the adhesive may be disposed onto the entirety of one side of the solid sheet. In certain embodiments, the adhesive is permeable to a solvent, such as a solvent contained in the polymer, and/or a solvent contained in the solid sheet.

In some embodiments, a solid sheet further contains a solvent. The solvent may be water, an organic solvent, or a combination thereof. The solvent optionally further contains an acid or a base.

In some embodiments, an outer surface of a solid sheet is covered by an impermeable transparent or translucent layer. An impermeable layer may be useful to slow drying of any liquids present, for example.

In some sensing systems, the carrier material is a liquid. The liquid may be water, an organic solvent, or a combination thereof. The organic solvent may be selected from the group consisting of alcohols, sulfoxides (e.g., dimethyl sulfoxide, DMSO), polyols, ketones, aldehydes, ethers, esters, and combinations thereof. Optionally, the liquid is thickened with a viscosity-modifying additive. Thickening may be beneficial to dispense the liquid from a pen, for example, or to contain the liquid in a smaller sensing region for the measurement.

In some sensing systems, the observable and quantifiable property change is a change in chromaticity of the responsive material. In these or other sensing systems, the observable and quantifiable property change is a change in optical transparency of the responsive material. In these or other sensing systems, the observable and quantifiable property change is a change in ionic conductivity of the responsive material. In these or other sensing systems, the observable and quantifiable property change is a change in electronic conductivity of the responsive material.

The polymer contains at least the discrete solid structural phase comprising and the continuous transport phase. Therefore, by definition, the polymer is a multi-phase polymer. In some embodiments, the polymer is a biphasic polymer, containing only two phases—the solid structural phase and the continuous transport phase.

In some embodiments, the solid structural polymer is selected from non-fluorinated carbon-based polymers. The non-fluorinated carbon-based polymers may be selected from the group consisting of polycarbonates, polyacrylates, polyalkanes, polyurethanes, polyethers, polyureas, polyesters, polyepoxides, and combinations thereof.

In some embodiments, the solid structural polymer is selected from fluorinated polymers. The fluorinated polymers may be selected from the group consisting of fluorinated polyols, perfluorocarbons, perfluoropolyethers, polyfluoroacrylates, polyfluorosiloxanes, polyvinylidene fluoride, polytrifluoroethylene, and combinations thereof. In certain embodiments, the fluorinated polymers are branched fluoropolymers with pendant reactive groups.

In some embodiments, the solid transport polymer is a hygroscopic solid transport polymer selected from the group consisting of poly(acrylic acid), poly(ethylene glycol), poly(2-hydroxyethyl methacrylate), poly(vinyl imidazole), poly(2-methyl-2-oxazoline), poly(2-ethyl-2-oxazoline), poly(vinylpyrolidone), modified cellulosic polymers, carboxymethyl cellulose, hydroxyethyl cellulose, hydroxypropyl cellulose, methyl cellulose, and combinations thereof.

In some embodiments, the solid transport polymer is a hydrophobic, non-lipophobic solid transport polymer selected from the group consisting of poly(propylene glycol), poly(tetramethylene glycol), polybutadiene, polycarbonate, polycaprolactone, acrylic polyols, and combinations thereof.

In some embodiments, the solid transport polymer is a hydrophilic solid transport polymer with ionic charge, and wherein the ionic charge is optionally present within the hydrophilic solid transport polymer as carboxylate groups, amine groups, sulfate groups, or phosphate groups.

In some embodiments, the solid transport polymer is an electrolyte solid transport polymer selected from the group consisting of polyethylene oxide, polypropylene oxide, polycarbonates, polysiloxanes, polyvinylidene difluoride, and combinations thereof.

In preferred embodiments, the solid structural polymer is crosslinked, via a crosslinker, with the solid structural polymer. The crosslinker may include at least one moiety selected from the group consisting of amine, hydroxyl, isocyanate, a blocked isocyanate, epoxide, carbodiimide, and combinations thereof.

In some embodiments, the discrete solid structural phase and the continuous transport phase are separated by an average phase-separation length selected from about 100 nanometers to about 500 microns.

In some embodiments, the antimicrobial agent is selected from quaternary ammonium molecules. The quaternary ammonium molecules may be selected from benzalkonium chloride, benzethonium chloride, methylbenzethonium chloride, cetalkonium chloride, cetylpyridinium chloride, cetyl trimethylammonium chloride, alkyltrimethylammonium chloride, tetraethylammonium chloride, didecyldimethylammonium chloride, dodecyl-dimethyl-(2-phenoxyethyl)azanium chloride, bromide versions thereof, or a combination of the foregoing. Other salts of quaternary ammonium may be employed as quaternary ammonium molecules.

In some embodiments, the antimicrobial agent is selected from metal ions. The metal ions may be selected from the group consisting of silver, copper, zinc, and combinations thereof.

In some embodiments, the antimicrobial agent is selected from metal oxides. The metal oxides may be selected from copper (I) oxide, copper (II) oxide, zinc oxide, silver oxide, and combinations thereof. The metal oxides may be in the form of metal oxide nanoparticles, microparticles, or a combination thereof.

In some embodiments, the antimicrobial agent is selected from acids. The acids may be selected from the group consisting of citric acid, acetic acid, peracetic acid, glycolic acid, lactic acid, succinic acid, pyruvic acid, oxalic acid, hydrochloric acid, and combinations thereof.

In some embodiments, the antimicrobial agent is selected from bases. The bases may be selected from the group consisting of ammonia, ammonium hydroxide, sodium hydroxide, potassium hydroxide, sodium bicarbonate, potassium bicarbonate, and combinations thereof.

In some embodiments, the antimicrobial agent is selected from salts. The salts may be selected from the group consisting of copper chloride, copper nitrate, copper citrate, copper acetate, copper lactate, zinc chloride, zinc nitrate, zinc citrate, zinc acetate, zinc lactate, silver chloride, silver nitrate, silver citrate, silver acetate, silver lactate, and combinations thereof.

In some embodiments, the antimicrobial agent is selected from oxidizing molecules. The oxidizing molecules may be selected from the group consisting of hypochlorous acid, hydrogen peroxide, sodium hypochlorite, sodium chlorite, sodium chlorate, calcium hypochlorite, calcium chlorite, calcium chlorate, calcium perchlorate, and combinations thereof.

### BRIEF DESCRIPTION OF THE FIGURES

The patent or application file contains at least one drawing executed in color. Copies of this patent or patent application publication with color drawings will be provided by the Office upon request and payment of the necessary fee.

FIG. 1A shows a surface indicator for quaternary ammonium halide elution after 15 seconds from an antimicrobial biphasic coating, in Example 1.

FIG. 1B shows a surface indicator for quaternary ammonium halide elution after about 1 minute from an antimicrobial biphasic coating, in Example 1.

FIG. 1C shows a surface indicator for quaternary ammonium halide elution after about 3 minutes from an antimicrobial biphasic coating, in Example 1.

FIG. 1D shows a surface indicator for quaternary ammonium halide elution after about 6 minutes from an antimicrobial biphasic coating, in Example 1.

FIG. 1E shows a surface indicator for quaternary ammonium halide elution after about 7 minutes from an antimicrobial biphasic coating, in Example 1.

FIG. 1F shows a surface indicator for quaternary ammonium halide elution after about 10 minutes from an antimicrobial biphasic coating, in Example 1.

FIG. 2A shows a starting (t=0) surface indicator for bleach elution from an antimicrobial biphasic coating, in Example 2.

FIG. 2B shows a surface indicator for bleach elution after 10 minutes from an antimicrobial biphasic coating, in Example 2.

FIG. 2C shows a surface indicator for bleach elution after 30 minutes from an antimicrobial biphasic coating, in Example 2.

FIG. 2D shows a surface indicator for bleach elution after 60 minutes from an antimicrobial biphasic coating, in Example 2.

### DETAILED DESCRIPTION OF EMBODIMENTS OF THE INVENTION

The systems and methods of the present invention will be described in detail by reference to various non-limiting embodiments.

This description will enable one skilled in the art to make and use the invention, and it describes several embodiments, adaptations, variations, alternatives, and uses of the invention. These and other embodiments, features, and advantages of the present invention will become more apparent to those skilled in the art when taken with reference to the following detailed description of the invention in conjunction with the accompanying figures.

As used in this specification and the appended claims, the singular forms “a,” “an,” and “the” include plural referents unless the context clearly indicates otherwise. Unless defined otherwise, all technical and scientific terms used herein have the same meaning as is commonly understood by one of ordinary skill in the art to which this invention belongs.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

All references to “room temperature” should be understood as about 25° C., which for purposes of this patent application means 25° C.±5° C.

Unless otherwise indicated, all references to Mₙ in this disclosure mean number-average molecular weight.

In this specification, “antimicrobial agent” is synonymous with “antimicrobial active” and such terms may be used interchangeably.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phrase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phrase “consisting essentially of” limits the scope of a claim to the specified elements or method steps, plus those that do not materially affect the basis and novel characteristic(s) of the claimed subject matter.

With respect to the terms “comprising,” “consisting of,” and “consisting essentially of,” where one of these three terms is used herein, the presently disclosed and claimed subject matter may include the use of either of the other two terms, except when used in a Markush group. Thus in some embodiments not otherwise explicitly recited, any instance of “comprising” may be replaced by “consisting of” or, alternatively, by “consisting essentially of.”

The present invention provides sensors placed on the surface of polymers (e.g., biphasic polymers) to measure the concentration of antimicrobial actives in the polymers.

The efficacious lifetime of antimicrobial polymers is limited by the amount of antimicrobial actives that can be stored in the polymers. When the concentration of antimicrobial actives falls below an effective amount, the antimicrobial actives may be replenished, such as described below and/or in U.S. patent application Ser. No. 17/968,886, filed on Oct. 19, 2022, which is incorporated by reference. To maximize the times between replenishment, there is a need to measure the concentration of antimicrobial actives in the polymers. This disclosure describes sensors that can be placed on the surface of the polymer, wherein a change in physical properties correlates to the concentration of antimicrobial actives.

Commercial applications include, but are not limited to, antimicrobial surfaces in cars, especially shared-ride vehicles, to inhibit the transfer of microbes from one person to another; antimicrobial surfaces in airplanes where UV light cannot reach, to sanitize contaminated surfaces; antimicrobial surfaces inside and outside vehicles that may be used to rescue or move people who have been exposed to diseases and pandemics; antimicrobial surfaces in homes (e.g. kitchens or bathrooms), in restaurants, and on clothing and personal protective equipment.

Some variations of the invention provide a sensing system (synonymously, antimicrobial structure) configured to measure the concentration of an antimicrobial agent in a polymer, the system comprising:

(a) a polymer containing (i) a discrete solid structural phase comprising a solid structural polymer and (ii) a continuous transport phase comprising a solid transport polymer, wherein the continuous transport phase is capable of containing the antimicrobial agent; and

(b) an antimicrobial-agent sensor that chemically senses the antimicrobial agent, wherein the antimicrobial-agent sensor is disposed on a surface of, and in mass transport with, the polymer,

wherein the antimicrobial-agent sensor contains a responsive material disposed on or within a carrier material,

wherein the responsive material is chemically reactive with the antimicrobial agent, and

wherein the responsive material exhibits an observable and quantifiable property change upon chemically reacting with the antimicrobial agent.

In some embodiments, the carrier material is a solid, such as a solid sheet. The solid sheet may be selected from the group consisting of a paper sheet, a plastic sheet, a metal or metal alloy sheet, a metal oxide sheet, a carbon sheet, and combinations thereof. The geometry of a “sheet” may vary, such as a square, a rectangle, or a circle, and may also be referred to as a strip, a pad, or a tab, for example.

The porosity of the carrier material may vary, from slightly porous to highly porous. In various embodiments, the volumetric porosity of the carrier material is about, at least about, or at most about 5%, 10%, 15%, 20%, 25%, 30%, 35%, 40%, 45%, 50%, 55%, 60%, 65%, 70%, or 75%, including any intervening ranges (e.g., 10-50%). Some porosity is typically needed to allow the antimicrobial agent to penetrate through the carrier material from the polymer to the antimicrobial-agent sensor. In certain embodiments, the carrier material is non-porous which may be acceptable when the antimicrobial agent is able to transport through the carrier material by another mechanism that does not rely on pore diffusion.

In some embodiments, a side of a solid sheet is completely covered by the responsive material. In certain embodiments, both sides of a solid sheet are completely covered by the responsive material.

In other embodiments, a side of a solid sheet is partially covered by the responsive material. For example, the responsive material may be printed on the solid sheet in the form of a letter, a symbol, or a word.

In some embodiments, a solid sheet is at least partially coated with an adhesive to attach (e.g., via intermolecular adsorption) the antimicrobial-agent sensor to the biphasic polymer. The adhesive may be disposed onto a portion of the solid sheet, such as the perimeter of the solid sheet. Alternatively, the adhesive may be disposed onto the entirety of one side of the solid sheet. In certain embodiments, the adhesive is permeable to a solvent, such as a solvent contained in the polymer, and/or a solvent contained in the solid sheet.

In some embodiments, a solid sheet further contains a solvent. The solvent may be water, an organic solvent, or a combination thereof. In some preferred embodiments the solvent in the solid sheet is water or an aqueous solution. The solvent optionally further contains an acid (e.g., acetic acid) or a base (e.g., calcium hydroxide).

In some embodiments, an outer surface of a solid sheet is covered by an impermeable transparent or translucent layer. In certain embodiments, both surfaces of a solid sheet are covered by impermeable transparent or translucent layers. An impermeable layer may be useful to slow drying of any liquids present, for example.

In some sensing systems, the carrier material is a liquid. The liquid may be water, an organic solvent, or a combination thereof. The organic solvent may be selected from the group consisting of alcohols, sulfoxides, polyols, ketones, aldehydes, ethers, esters, and combinations thereof. Although less preferred, the liquid may be an inorganic solvent, such as a hydrogen peroxide; or a combination of water and an inorganic solvent, such as ammonia dissolved in water.

When the carrier material is a liquid, the liquid may be thickened with a viscosity-modifying additive. Thickening may be beneficial to dispense the liquid from a pen, for example, or to contain the liquid within a smaller sensing region for the measurement. Exemplary viscosity-modifying additives include, but are not limited to, carboxymethylcellulose, xanthan gum, guar gum, and starch. The carrier material with viscosity-modifying additive may have a viscosity selected from about 0.1 Pa s to about 100 Pa s, such as from about 1 Pa s to about 20 Pa s, measured at 25° C. For comparison, water has a viscosity of 0.001 Pa s at 25° C. In various embodiments, the carrier material has a viscosity at 25° C. of about, at least about, or at most about 0.1, 0.2, 0.5, 1, 2, 3, 4, 5, 6, 7, 8, 9, 10, 15, 20, 25, 30, 40, 50, 60, 70, 80, 90, or 100 Pa s, including any intervening ranges.

The responsive material may be a liquid dissolved in another liquid (carrier material), a solid dissolved in a liquid, or a solid suspended in a liquid, for example. The responsive material may be a material that would ordinarily be a vapor at ambient conditions but is (a) dissolved or suspended in a liquid, or (b) adsorbed onto molecules of the carrier material, which may be liquid or solid.

In some sensing systems, whether the carrier material is a solid or a liquid, the observable and quantifiable property change is a change in chromaticity of the responsive material. In these embodiments, the responsive material undergoes a change in chromaticity when there is a change in concentration of antimicrobial agent. Chromaticity and color are related but not exactly the same.

Color is the spectral composition of visible light while chromaticity is an objective specification of the quality of a color, regardless of its luminance. Luminance is the intensity of light emitted from a surface per unit area in a given direction. Luminance is an indicator of how bright a surface appears to a human eye. When luminance is fixed or constant, then color and chromaticity are effectively the same parameters being measured. In typical embodiments, color is monitored rather than chromaticity, it being understood that if luminance is changing, then chromaticity is preferred over color. In certain embodiments, color is monitored even if luminance is changing, ignoring any contribution of luminance to the measurement.

Chromaticity consists of two independent parameters, often specified as hue and saturation. Hue can be represented quantitatively by a single number, corresponding to an angular position around a central or neutral point or axis on a color space chromaticity coordinate diagram. Saturation is the colorfulness of an area judged in proportion to its brightness. An object with a given spectral reflectance exhibits approximately constant saturation for all levels of illumination, unless the brightness is very high.

A chromaticity-coordinates model may be utilized in conjunction with a spectrum analyzer, as described in U.S. Pat. No. 10,533,993, which is hereby incorporated by reference. In some sensing systems, the observable and quantifiable property change is a change in one coordinate of chromaticity of the responsive material. In some sensing systems, the observable and quantifiable property change is a change in multiple coordinates of chromaticity of the responsive material.

The chromaticity (e.g., the hue and/or the saturation) may be observed to change by a percentage from about 0.1% to about 100% or more, such as about 0.2%, 0.5%, 1%, 2%, 3%, 4%, 5%, 10%, 15%, 20%, 25%, 30%, 40%, 50%, 60%, 70%, 80%, 90%, 100%, 150%, 200%, 250%, 300%, 400%, or 500%, including any intervening ranges. These percentages refer to the relative change in a first (initial) value, such as with no antimicrobial agent yet present in the sensor, to a second value in which there is some antimicrobial agent present in the sensor following diffusion out of the biphasic polymer. Also, these percentages are magnitudes and may be either positive or negative. For example, if the chromaticity is reduced by 50% with antimicrobial agent present, the chromaticity change is −50%. If the chromaticity is increased by 20% with antimicrobial agent present, the chromaticity change is +20%.

A human eye can be used to evaluate color and chromaticity. Alternatively, a spectrum analyzer, reflectometer, spectrophotometer, colorimeter, camera, or other digital reader may be employed for more quantitative analysis than is typically possible when using color-chart comparisons by a human eye. A computer may be configured to acquire measurement data (e.g., an image) and convert that data into a chromaticity value.

In certain embodiments, a colorimeter passes a white light beam through an optical filter which transmits only one particular color or band of wavelengths of light to a photodetector, where the light is measured. The difference in the amount of colored light transmitted by a colorless sample (blank), and the amount of colored light transmitted by a colored sample (with antimicrobial agent), is a measurement of the amount of colored light absorbed by the sample. In typical colorimetric tests, the amount of colored light absorbed is directly proportional to the concentration, and is reported by the meter.

In sensing systems that measure a change in chromaticity, the responsive material may be selected from acid-base indicators. Acid-base indicators are compounds that change color when they become protonated or deprotonated. Acid-base indicators may be selected from indicator dyes, which may be natural indicator dyes, synthetic indicator dyes, or a combination thereof. Exemplary natural indicator dyes include archil, litmus, turnsole, logwood, and red cabbage, for example. Exemplary synthetic indicator dyes include phenolphthalein, dinitrophenol, bromocresol green, phenol red, chlorophenol red, methyl red, bromophenol blue, and thymol blue, for example. Combinations of multiple natural indicator dyes and/or multiple synthetic indicator dyes may be employed as the response material.

In some embodiments, a responsive material does not measure the concentration of an antimicrobial agent directly, but rather uses an acid-base indicator, buffer, surfactant, and potentially other components to create a micro-environment on the sensor such that the acid-base indicator reacts to the presence of the antimicrobial agent rather than the local pH. The interaction between the molecules of the acid-base indicator (e.g., indicator dye) and antimicrobial agent results in an observably different color. This chemistry is based on a phenomenon known as pH indicator error, when an indicator dye changes color without a change in solution pH. This phenomenon can be utilized on the sensor by adding a carefully calculated amount of buffer that excludes any contribution to pH other than the antimicrobial agent itself. It is this “error” that is employed for the detection of compounds of interest (here, the antimicrobial agent), in some embodiments.

In some sensing systems, whether the carrier material is a solid or a liquid, the observable and quantifiable property change is a change in optical transparency of the responsive material. Optical transparency can be determined by passing light through an object of defined thickness (e.g., 100 microns) and comparing the intensity of the transmitted light with the intensity of the incident light. An absorbance measurement may be made in a photometer. Alternatively, or additionally, a spectrophotometer may be utilized to measure the optical transparency.

In embodiments that measure optical transparency, the responsive material may contain an optically transparent polymer, an optically transparent glass, an optically transparent ceramic, or a combination thereof. An exemplary optically transparent polymer is polycarbonate. An exemplary optically transparent glass is ordinary silica glass. An exemplary optically transparent ceramic is aluminum oxynitride. In order to function as a responsive material to detect the presence of the antimicrobial agent, the optically transparent polymer, glass, or ceramic may be chemically modified with one or more functional groups that chemically interact with the antimicrobial agent, if the native material does not have the desired chemical reactivity.

In typical embodiments, the optical transparency has an inverse correlation with concentration of antimicrobial agent and consequent chemical reactions with the responsive material. When there is an inverse (negative) correlation, as the concentration of antimicrobial agent increases, the optical transparency decreases. In other embodiments, the optical transparency has a positive correlation with concentration of antimicrobial agent and consequent chemical reactions with the responsive material. When there is a positive correlation, as the concentration of antimicrobial agent increases, the optical transparency actually increases, such as via surface chemistry that removes optically opaque functional groups.

The optical transparency may be observed to change by a percentage from about 0.1% to about 100%, such as about 0.2%, 0.5%, 1%, 2%, 3%, 4%, 5%, 10%, 15%, 20%, 25%, 30%, 40%, 50%, 60%, 70%, 80%, 90%, 95%, 99%, or 100%, including any intervening ranges. These percentages refer to the absolute change in a first (initial) value, such as with no antimicrobial agent yet present in the sensor, to a second value in which there is some antimicrobial agent present in the sensor following diffusion out of the biphasic polymer, in units of % optical transparency (100%=fully optically transparent; 0%=optically opaque). As an example, if the initial optical transparency is 80% and the second optical transparency falls to 25% due to the presence of the antimicrobial agent in the sensor, then the change in optical transparency is 25%-80%=−55%. These percentages are magnitudes and may be either positive or negative. For example, if the optical transparency is reduced by 40% when the antimicrobial agent is present, the optical-transparency change is −40%. If the optical transparency is increased by 25% when the antimicrobial agent is present, the optical-transparency change is +25%.

In some sensing systems, whether the carrier material is a solid or a liquid, the observable and quantifiable property change is a change in ionic conductivity of the responsive material. In these embodiments, the responsive material may be an acid, a base, a salt, a solid ion conductor, a polymer electrolyte, an ionic liquid, a metal oxide, metal ions, carbon, or a combination thereof. Exemplary acids include hypochlorous acid and lactic acid. Exemplary bases include sodium hydroxide and potassium hydroxide. Exemplary salts include sodium chloride and potassium carbonate. An exemplary solid ion conductor is Li₂₊₂ₓZnₓGeO₄ (−0.5<x<1). Exemplary polymer electrolytes include poly(vinyl chloride) and poly(caprolactone). An exemplary ionic liquid is 1-butyl-3-methylimidazolium hexafluorophosphate. Exemplary metal oxides include vanadium oxide and manganese oxide. Exemplary metal ions include copper ions and nickel ions. Exemplary carbons include glassy carbon and carbon fiber.

To measure ionic conductivity in the responsive material, an ion conductivity meter may be utilized. In some embodiments, electrochemical impedance spectroscopy is employed. Other known means of measuring, estimating, or indirectly monitoring ion conductivity may be utilized, such as via electrodes, batteries, fuel cells, salt bridges, ionic-liquid reservoirs, or electromagnetic detectors, for example.

The ionic conductivity may increase or decrease with higher concentrations of antimicrobial agent. The ionic conductivity may be observed to change by a percentage from about 0.1% to about 1000% or more, such as about 0.5%, 1%, 5%, 10%, 25%, 50%, 100%, 200%, 300%, 400%, 500%, 600%, 700%, 800%, 900%, 1000%, or more, including any intervening ranges. These percentages refer to the relative change in a first (initial) value, such as with no antimicrobial agent yet present in the sensor, to a second value in which there is some antimicrobial agent present in the sensor following diffusion out of the biphasic polymer. Also, these percentages are magnitudes and may be either positive or negative, with the constraint that the change cannot be more negative than −100% which would represent a sensed material with no detected ionic conductivity. For example, if the ionic conductivity is increased five-fold with antimicrobial agent present, the ionic-conductivity change is +400%. Also note that the change in ionic conductivity can be even greater than one order of magnitude (10×), such as two, three, four, five, or more orders of magnitude.

In some sensing systems, whether the carrier material is a solid or a liquid, the observable and quantifiable property change is a change in electronic conductivity of the responsive material. In these embodiments, the responsive material may be a metal oxide, metal ions, carbon, a polymer electron conductor, an acid, a base, a salt, or a combination thereof. Exemplary metal ions include copper ions and nickel ions. Exemplary metal oxides include vanadium oxide and nickel oxide. Exemplary carbons include carbon fiber and graphene. Exemplary polymer electron conductors include poly(vinyl chloride) and poly(caprolactone). Exemplary acids include hypochlorous acid and lactic acid. Exemplary bases include sodium hydroxide and ammonium hydroxide. Exemplary salts include potassium chloride and calcium carbonate.

To measure electronic conductivity in the responsive material, an electronic conductivity meter may be utilized. In some embodiments, electrochemical impedance spectroscopy is employed. Other known means of measuring, estimating, or indirectly monitoring electronic conductivity may be utilized, such as via electrodes, batteries, fuel cells, salt bridges, electromagnets, or electromagnetic detectors, for example.

The electronic conductivity may increase or decrease with higher concentrations of antimicrobial agent. The electronic conductivity may be observed to change by a percentage from about 0.1% to about 1000% or more, such as about 0.5%, 1%, 5%, 10%, 25%, 50%, 100%, 200%, 300%, 400%, 500%, 600%, 700%, 800%, 900%, 1000%, or more, including any intervening ranges. These percentages refer to the relative change in a first (initial) value, such as with no antimicrobial agent yet present in the sensor, to a second value in which there is some antimicrobial agent present in the sensor following diffusion out of the biphasic polymer. Also, these percentages are magnitudes and may be either positive or negative, with the constraint that the change cannot be more negative than −100% which would represent a sensed material with no detected electronic conductivity. For example, if the electronic conductivity is increased 400% when the antimicrobial agent is present, the electronic-conductivity change is +400%. Also note that the change in electronic conductivity can be even greater than one order of magnitude (10×), such as two, three, four, five, or more orders of magnitude.

In some embodiments, the sensor is configured to detect multiple property changes. In certain sensing systems, whether the carrier material is a solid or a liquid, one or more observable and quantifiable property changes include chromaticity, optical transparency, ionic conductivity, electronic conductivity, such as any two of these parameters, any three of these parameters, or all four of these parameters. When multiple properties are measured, they may be assessed independently, such as to cross-check estimates of concentration or determine an average value. An algorithm may be developed to account for multiple properties being measured simultaneously, such as to deconvolute the multiple responses and provide a single concentration value that best fits the multiple measurements.

The antimicrobial-agent sensor detects the antimicrobial-agent concentration on the polymer surface, rather than the concentration of antimicrobial agent within the bulk phase of the polymer. The surface concentration is more relevant than the bulk concentration, because the surface is exposed to the virus or other pathogen.

The polymer contains at least the discrete solid structural phase and the continuous transport phase. Therefore, the polymer is a multiphase polymer. In some embodiments, the polymer is a biphasic polymer, containing only two phases—the solid structural phase and the continuous transport phase. In certain embodiments, the polymer is a polyphasic polymer with more than two phases (in addition to the antimicrobial agent).

In some embodiments, the solid structural polymer is selected from non-fluorinated carbon-based polymers. The non-fluorinated carbon-based polymers may be selected from the group consisting of polycarbonates, polyacrylates, polyalkanes, polyurethanes, polyethers, polyureas, polyesters, polyepoxides, and combinations thereof.

In some embodiments, the solid structural polymer is selected from fluorinated polymers. The fluorinated polymers may be selected from the group consisting of fluorinated polyols, perfluorocarbons, perfluoropolyethers, polyfluoroacrylates, polyfluorosiloxanes, polyvinylidene fluoride, polytrifluoroethylene, and combinations thereof. In certain embodiments, the fluorinated polymers are branched fluoropolymers with pendant reactive groups.

In some embodiments, the solid transport polymer is a hygroscopic solid transport polymer selected from the group consisting of poly(acrylic acid), poly(ethylene glycol), poly(2-hydroxyethyl methacrylate), poly(vinyl imidazole), poly(2-methyl-2-oxazoline), poly(2-ethyl-2-oxazoline), poly(vinylpyrolidone), modified cellulosic polymers, carboxymethyl cellulose, hydroxyethyl cellulose, hydroxypropyl cellulose, methyl cellulose, and combinations thereof. For instance, a hygroscopic solid transport polymer may be a crosslinked poly(acrylic acid) emulsion polymer (e.g., Carbopol® polymers) that can bind with antimicrobial agents.

In some embodiments, the solid transport polymer is a hydrophobic, non-lipophobic solid transport polymer selected from the group consisting of poly(propylene glycol), poly(tetramethylene glycol) (PTMEG, also known as polytetrahydrofuran or pTHF), polybutadiene, polycarbonate, polycaprolactone, acrylic polyols, and combinations thereof.

In some embodiments, the solid transport material is or includes a hydrophilic solid transport polymer. The hydrophilic solid transport polymer may be a polymer created with ionic charge that may be present within the hydrophilic solid transport polymer as pendant or main-chain carboxylate groups, amine groups, ammonium groups, sulfate groups, or phosphate groups, for example. In certain embodiments, monomers containing ionic charge are inserted along the polymer backbone. The hydrophilic solid transport polymer may bind with antimicrobial agents.

In some embodiments, the solid transport polymer is an electrolyte solid transport polymer selected from the group consisting of polyethylene oxide, polypropylene oxide, polycarbonates, polysiloxanes, polyvinylidene difluoride, and combinations thereof.

In preferred antimicrobial structures, the solid structural polymer is covalently bonded to the solid transport material. In preferred embodiments, a solid structural polymer is crosslinked, via a crosslinking molecule, with a solid transport polymer. The crosslinking is preferably covalent crosslinking, but can also be ionic crosslinking. When the discrete and continuous phases are covalently crosslinked, an abrasion-resistant structure is established within the continuous transport phase. Additionally, when the structural polymer and the transport polymer are crosslinked, the length scales of the different phases can be controlled, such as to enhance transport rates of the antimicrobial agent. The crosslinking molecule may include at least one moiety selected from the group consisting of amine, hydroxyl, isocyanate, a blocked isocyanate, epoxide, carbodiimide, and combinations thereof.

In some embodiments, the discrete solid structural phase and the continuous transport phase are separated by an average phase-separation length selected from about 100 nanometers to about 500 microns.

In some embodiments, the antimicrobial agent is selected from quaternary ammonium molecules. The quaternary ammonium molecules may be selected from benzalkonium chloride, benzethonium chloride, methylbenzethonium chloride, cetalkonium chloride, cetylpyridinium chloride, cetyl trimethylammonium chloride, alkyltrimethylammonium chloride, tetraethylammonium chloride, didecyldimethylammonium chloride, dodecyl-dimethyl-(2-phenoxyethyl)azanium chloride, bromide versions thereof, or a combination of the foregoing. Other salts of quaternary ammonium may be employed as quaternary ammonium molecules.

In some embodiments, the antimicrobial agent is selected from metal ions. The metal ions may be selected from the group consisting of silver, copper, zinc, and combinations thereof.

In some embodiments, the antimicrobial agent is selected from metal oxides. The metal oxides may be selected from copper (I) oxide, copper (II) oxide, zinc oxide, silver oxide, and combinations thereof. The metal oxides may be in the form of metal oxide nanoparticles, microparticles, or a combination thereof.

In some embodiments, the antimicrobial agent is selected from acids. The acids may be selected from the group consisting of citric acid, acetic acid, peracetic acid, glycolic acid, lactic acid, succinic acid, pyruvic acid, oxalic acid, hydrochloric acid, and combinations thereof.

In some embodiments, the antimicrobial agent is selected from bases. The bases may be selected from the group consisting of ammonia, ammonium hydroxide, sodium hydroxide, potassium hydroxide, sodium bicarbonate, potassium bicarbonate, and combinations thereof.

In some embodiments, the antimicrobial agent is selected from salts. The salts may be selected from the group consisting of copper chloride, copper nitrate, copper citrate, copper acetate, copper lactate, zinc chloride, zinc nitrate, zinc citrate, zinc acetate, zinc lactate, silver chloride, silver nitrate, silver citrate, silver acetate, silver lactate, and combinations thereof.

In some embodiments, the antimicrobial agent is selected from oxidizing molecules. The oxidizing molecules may be selected from the group consisting of hypochlorous acid, hydrogen peroxide, sodium hypochlorite, sodium chlorite, sodium chlorate, calcium hypochlorite, calcium chlorite, calcium chlorate, calcium perchlorate, and combinations thereof.

The antimicrobial agent preferably is not in the form of purely solid particles. In preferred embodiments, the antimicrobial agent is not in the form of solid particles at temperatures of use (e.g., 20-40° C.). Quaternary ammonium salts are deliquescent and will advantageously form a concentrated solution that typically does not dry out. Quaternary ammonium salts may be dissolved in a solvent, such as ethylene glycol or oligomers thereof. Hypochlorous acid, sodium hypochlorite, calcium hypochlorite, and hydrogen peroxide only exist as solutions or liquids, practically speaking. Hypochlorous acid and sodium hypochlorite are never found dry because they decompose with increasing concentration before they dry out. Hydrogen peroxide is a liquid above −0.4° C. at 1 bar pressure.

The antimicrobial agent may be at least partially dissolved in a fluid that is contained within the continuous transport phase. The fluid may be selected from the group consisting of water, dialkyl carbonate, propylene carbonate, γ-butyrolactone, 2-phenoxyethanol, dimethyl sulfoxide, t-butanol, glycerol, propylene glycol, ionic liquids, and combinations thereof, for example.

Some variations provide methods of making and/or using the sensing system. For example, in some variations, a sensing solid sheet is made and used by:

(a) printing a responsive material on a sheet of carrier material;

(b) optionally applying an adhesive to one side of the carrier material;

(c) cutting out stickers or smaller sections of the solid sheet to act as individual sensors;

(d) optionally wetting the sensors with a solvent;

(e) placing the sensors on a polymer; and

(f) observing a property change in the sensors, thereby indicating the concentration of antimicrobial actives in the polymer.

In some variations, a sensing liquid is made and used by:

(a) adding a responsive material into a solvent, to create a sensing liquid;

(b) adding a thickener to the sensing liquid;

(c) putting the sensing liquid in a dispenser;

(d) dispensing the sensing liquid on a polymer; and

(e) observing a property change in the sensing liquid, thereby indicating the concentration of antimicrobial actives in the polymer.

The efficacious lifetime of antimicrobial polymers is limited by the physical durability of the polymers and the amount of antimicrobial agent that can be stored in the polymers. There is an engineering trade-off between durability and effective lifetime. In particular, as more antimicrobial agent is incorporated and the polymer is modified to allow the antimicrobial agent to reach the polymer surface, durability may be compromised.

The disclosed antimicrobial biphasic polymers avoid the aforementioned trade-off between durability and lifetime by enabling timely sensing and replenishment of the antimicrobial actives over the lifetime of the coating. In preferred embodiments, the antimicrobial biphasic polymers have a biphasic structure with an anti-fouling and durable discrete phase combined with a continuous antimicrobial active storage and transport phase. The discrete phase provides the durability of a conventional polyurethane, while the transport phase allows greater movement and absorption of antimicrobial actives through the coating than a traditional, single-phase durable coating.

Biphasic polymers can eventually become depleted of antimicrobial actives through surface cleaning, consumption of antimicrobial actives, decomposition of antimicrobial actives, vaporization of antimicrobial actives, or other reasons. The degree of depletion of antimicrobial actives can be effectively measured or monitored using the disclosed sensors. A measurement or signal from the antimicrobial-agent sensor can be used to activate a replenishment step.

In some variations, the transport phase is present throughout the antimicrobial biphasic polymer. Replenishment of antimicrobial actives is enabled by contacting the top surface of the antimicrobial biphasic polymer with a concentrated replenishment solution of antimicrobial actives. The replenishment solution enters into, and is distributed throughout, the transport phase. Replenishment extends the efficacious lifetime of the coating repeatedly.

Some variations provide a method of filling or replenishing an antimicrobial agent in a biphasic polymer, the method comprising:

(a) selecting an antimicrobial agent;

(b) providing a biphasic polymer that is designed to contain the antimicrobial agent;

(c) using a sensor, measuring a concentration of the antimicrobial agent within the biphasic polymer;

(d) providing a replenishment solution comprising a quantity of the antimicrobial agent and an antimicrobial-agent solvent;

(e) applying the replenishment solution to the biphasic polymer; and

(f) removing excess replenishment solution, if any, from the biphasic polymer, thereby generating an antimicrobial-agent-replenished biphasic polymer.

In typical embodiments, the replenishment solution is applied to replenish the antimicrobial agent in the biphasic polymer, after receiving a sensing measurement or signal from the sensor. In some embodiments, the replenishment solution is applied to the biphasic polymer for the first time.

The biphasic polymer may contain a discrete solid structural phase and a continuous transport phase that is interspersed within the discrete solid structural phase, wherein the continuous transport phase is capable of storing and transporting the antimicrobial agent.

The biphasic polymer may be a polymer described in U.S. Pat. No. 10,689,542, issued on Jun. 23, 2020; U.S. Pat. No. 11,225,589, issued on Jan. 18, 2022; and/or U.S. Pat. No. 11,369,109, issued on Jun. 28, 2022, each of which is hereby incorporated by reference herein for all purposes.

In some embodiments, the discrete solid structural phase is covalently bonded to the continuous transport phase. In certain embodiments, the discrete solid structural phase is crosslinked, via a crosslinking molecule, with the continuous transport phase.

In some embodiments, the discrete solid structural phase and the continuous transport phase are separated by an average phase-separation length selected from about 100 nanometers to about 500 microns. Phase-separation length scales are further described later in this specification.

In some embodiments, the continuous transport phase contains a fluid, wherein the antimicrobial agent is at least partially dissolved in the fluid. The fluid may be selected from the group consisting of water, alcohols, sulfoxides, polyols, ketones, ethers, esters, carbonates, sulfoxides, ionic liquids, and combinations thereof, for example. Exemplary fluids are water, dialkyl carbonate, propylene carbonate, 7-butyrolactone, 2-phenoxyethanol, dimethyl sulfoxide, t-butanol, glycerol, propylene glycol, and ionic liquids.

In some methods, the biphasic polymer is being filled for the first time. In these embodiments, the biphasic polymer initially contains no measurable concentration of the antimicrobial agent (according to the sensor), and the biphasic polymer never previously contained a non-zero concentration of the antimicrobial agent.

After the biphasic polymer is initially loaded with an antimicrobial agent, the concentration of antimicrobial agent in the biphasic polymer may be from about 1 ppm to about 10 wt % (based on all components present), depending on the specific antimicrobial agent and/or other factors. In various embodiments, the concentration of antimicrobial agent in the biphasic polymer is about, at least about, or at most about 1 ppm, 10 ppm, 25 ppm, 50 ppm, 100 ppm, 200 ppm, 300 ppm, 400 ppm, 500 ppm, 0.1 wt %, 0.2 wt %, 0.5 wt %, 1 wt %, 2 wt %, 5 wt %, or 10 wt %, including any intervening ranges.

In certain embodiments that fill the biphasic polymer for the first time, the method further comprises treating the biphasic polymer with a polymer-opening solvent to enhance absorption of the antimicrobial agent in the biphasic polymer. The polymer-opening solvent may be selected from the group consisting of water, alcohols, sulfoxides, polyols, ketones, ethers, esters, carbonates, sulfoxides, ionic liquids, and combinations thereof. A certain preferred polymer-opening solvent is 75 vol % water and 25 vol % acetone.

In some methods, after applying a replenishment solution, the concentration of antimicrobial agent in the biphasic polymer may be from about 1 ppm to about 10 wt % (based on all components present). In various embodiments, after applying a replenishment solution, the concentration of antimicrobial agent in the biphasic polymer is about, at least about, or at most about 1 ppm, 5 ppm, 10 ppm, 25 ppm, 50 ppm, 100 ppm, 150 ppm, 200 ppm, 300 ppm, 400 ppm, 500 ppm, 0.1 wt %, 0.2 wt %, 0.5 wt %, 1 wt %, 2 wt %, 5 wt %, or 10 wt %, including any intervening ranges. The concentration of antimicrobial agent may be provided directly or indirectly from a sensor, as described elsewhere.

Application of a replenishment solution may return the concentration of antimicrobial agent in the biphasic polymer to the original value, or less than the original value, or greater than the original value. In various embodiments, after applying a replenishment solution, the concentration of antimicrobial agent in the biphasic polymer is about, at least about, or at most about 10%, 20%, 30%, 40%, 50%, 60%, 70%, 80%, 90%, 95%, 100%, 105%, 110%, 120%, 130%, 140%, 150%, or 200% of the original concentration of antimicrobial agent in the biphasic polymer after the initial filling but prior to any replenishment. When there are multiple replenishments during the lifetime of a biphasic polymer, the percentage of original antimicrobial-agent concentration may vary, i.e., each replenishment need not return the biphasic polymer to the same original concentration.

In certain methods, the biphasic polymer contains no measurable concentration of the antimicrobial agent, but the biphasic polymer previously contained a non-zero concentration of the antimicrobial agent. These embodiments may be indicative of the total consumption or loss of antimicrobial actives, which is usually not desirable.

Some embodiments measure the concentration of the antimicrobial agent during use of the biphasic polymer and then replenish with more antimicrobial agent once it reaches a critical concentration, such as 10% to 50% of the original concentration. In various embodiments, the biphasic polymer is replenished with more antimicrobial agent when its concentration reaches about 1%, 2%, 5%, 10%, 15%, 20%, 25%, 30%, 35%, 40%, 45%, 50%, 55%, 60%, 70%, or 80%, including any intervening ranges, of the original concentration of the antimicrobial agent in the biphasic polymer.

Also, a concentration of the antimicrobial agent within the biphasic polymer may be measured at other times during the method, if desired. For example, the concentration of the antimicrobial agent may be measured after step (e) but prior to step (f), such as to determine whether excess replenishment solution should be removed. Alternatively, or additionally, the concentration of the antimicrobial agent may be measured after step (f), such as to determine whether removal of excess replenishment solution was effective.

An antimicrobial-agent solvent may be selected from the group consisting of water, alcohols, sulfoxides, polyols, ketones, ethers, esters, carbonates, sulfoxides, ionic liquids, and combinations thereof, for example. Exemplary antimicrobial-agent solvents include, but are not limited to, ethanol, isopropanol, n-butanol, t-butanol, DMSO, and ethylene glycol butyl ether (2-butoxyethanol).

In some embodiments, the replenishment solution further includes a wetting agent, a cleaning agent, a surfactant, a low-surface-tension solvent, nanoparticles for Pickering emulsions, or a combination thereof.

The method may further comprise cleaning a surface of the biphasic polymer. Such a cleaning step may be performed to prepare the biphasic polymer for replenishment, or to remove debris, for example. The surface of the biphasic polymer may be cleaned at various times, and at various steps.

There are many ways to apply the replenishment solution to the biphasic polymer.

In some methods, step (e) includes wiping the replenishment solution on a surface of the biphasic polymer. In this specification, “wiping” means the application of the replenishment solution to a surface of the biphasic polymer using an object or film that itself contains an absorbed or adsorbed amount of replenishment solution, in a manner that transfers at least some of the replenishment solution from the object or film to the biphasic polymer. The wiping may use one or multiple passes of the object or film across the biphasic polymer, and the wiping speed (and thus wiping time) may vary to enable sufficient transfer of the replenishment solution. The wiping time may vary, such as from 30 seconds to 1 hour, for example.

In some methods, step (e) includes painting the replenishment solution on a surface of the biphasic polymer. In this specification, “painting” means the application of the replenishment solution to a surface of the biphasic polymer using a brush, airbrush, knife, sponge, or other suitable painting device. The painting may use one or, more typically, multiple passes of the painting device over the surface of the biphasic polymer, and the painting speed (and this painting time) and number of paint strokes may vary to enable sufficient application of the replenishment solution. The painting time may vary, such as from 1 minute to 1 hour, for example.

In some methods, step (e) includes spraying the replenishment solution on a surface of the biphasic polymer. In this specification, “spraying” means the application of the replenishment solution to a surface of the biphasic polymer by impinging liquid droplets from a spraying device, such as a nozzle. The spraying time may vary to enable sufficient application of the replenishment solution. The spraying time may vary, such as from 10 seconds to 30 minutes, for example.

In some methods, step (e) includes submerging a surface of the biphasic polymer in the replenishment solution. In this specification, “submerging” means completely immersing the biphasic polymer into a bath of excess replenishment solution. immersion time may vary to enable sufficient take-up of the replenishment solution into the biphasic polymer. The immersion time may vary, such as from 5 minutes to 8 hours, for example.

In some methods, step (e) includes heating of the biphasic polymer and/or the replenishment solution to enhance penetration of the replenishment solution in the biphasic polymer. For example, the biphasic polymer may be heated during exposure to the replenishment solution. The replenishment solution may be applied to a coating that may or may not itself be heated. The heating of the biphasic polymer may bring the temperature of the polymer up to 30° C., 40° C., 50° C., 60° C., 70° C., 80° C., or 90° C., for example, including any intervening ranges. The heating of the replenishment solution may bring the temperature of the replenishment solution up to 30° C., 40° C., 50° C., 60° C., 70° C., 80° C., or 90° C., for example, including any intervening ranges.

In some methods, step (f) includes wiping the excess replenishment solution off a surface of the biphasic polymer using an absorptive article, such as (but not limited to) an article containing cellulose and/or polyacrylic acid.

In some methods, step (f) includes washing a surface of the biphasic polymer using a liquid solvent. Washing of the surface of the biphasic polymer may utilize water, an aqueous solvent (e.g., ethanol/acetone/water), or another suitable solvent (e.g. isopropyl alcohol or glycerol.) The liquid solvent for washing, when employed, may be the same as, or different than, the solvent for the antimicrobial agent.

The biphasic polymer may be present in a coating on a substrate. The substrate may be a metal, a metal alloy, a polymer, wood, carbon, ceramic, or another substrate material. Alternatively, there is no distinct substrate; rather, the biphasic polymer is disposed in a surface region of a bulk object.

Method steps may be carried out in various sequences.

Some variations provide a method of filling or replenishing an antimicrobial agent in a biphasic polymer, the method comprising:

(a) selecting an antimicrobial agent;

(b) providing a biphasic polymer that is designed to contain the antimicrobial agent;

(c) providing a replenishment solution comprising a quantity of the antimicrobial agent and an antimicrobial-agent solvent;

(d) applying the replenishment solution to the biphasic polymer;

(e) periodically or continuously measuring a concentration of the antimicrobial agent within the biphasic polymer, using an antimicrobial-agent sensor; and

(f) optionally removing excess replenishment solution, if any, from the biphasic polymer,

thereby generating an antimicrobial-agent-replenished biphasic polymer.

Some variations provide a method of filling or replenishing an antimicrobial agent in a biphasic polymer, the method comprising:

selecting an antimicrobial agent;

providing a biphasic polymer that is designed to contain the antimicrobial agent;

providing a replenishment solution comprising a quantity of the antimicrobial agent and an antimicrobial-agent solvent; and

based on a measurement or signal from an antimicrobial-agent sensor, applying the replenishment solution to the biphasic polymer.

Other variations provide a system for filling or replenishing an antimicrobial agent in a biphasic polymer, the system comprising:

(a) an antimicrobial agent;

(b) a biphasic polymer that is capable of containing the antimicrobial agent;

(c) an antimicrobial-agent sensor configured for measuring a concentration of the antimicrobial agent within the biphasic polymer;

(d) a replenishment solution comprising a quantity of antimicrobial agent and an antimicrobial-agent solvent, wherein the replenishment solution is capable of being applied to the biphasic polymer;

(e) an antimicrobial-agent sensor disposed on a surface of the biphasic polymer; and

(f) means for applying the replenishment solution to the biphasic polymer.

Some embodiments utilize a sensor but not necessarily a replenishment solution. For example, a solution of antimicrobial agent may be charged initially into a biphasic polymer adapted with an antimicrobial-agent sensor. The sensor may be used to determine when too much antimicrobial agent has been lost or decomposed, at which point use of the biphasic polymer may be discontinued, rather than be replenished with more antimicrobial agent.

Some variations provide a method of sensing an antimicrobial agent in a biphasic polymer, the method comprising:

(a) selecting an antimicrobial agent;

(b) providing a biphasic polymer that is designed to contain the antimicrobial agent;

(c) applying the replenishment solution to the biphasic polymer;

(d) initially and/or after one or more periods of use of the biphasic polymers, utilizing a sensor to measure a concentration of the antimicrobial agent within the biphasic polymer; and

(e) optionally, (e1) replenishing the biphasic polymer with more antimicrobial agent based on a measurement from step (d); or (e2) discontinuing use of the biphasic polymer based on a measurement from step (d).

In some embodiments, a biphasic-polymer coating is stain-resistant due to the presence of fluorinated polymers or additives. Fluorinated materials have low surface energies which reduce the penetration of liquid contaminants, thereby enhancing stain resistance.

In some embodiments, a biphasic-polymer coating is stain-resistant without the use of fluorinated polymers or additives. The stain resistance arises from the incorporation of materials with a glass-transition temperature above room temperature, instead of requiring fluorinated materials to avoid soil infiltration.

In some embodiments, a biphasic-polymer coating contains a discrete solid structural phase combined with a continuous transport phase. The discrete solid structural phase provides mechanical integrity and anti-fouling characteristics (stain resistance). The continuous transport phase acts as a medium for the fast diffusion of antimicrobial agents.

In some variations, a stain-resistant coating is optically transparent. The transparency is unexpected in phase-separated polymers (biphasic polymers) with micron-size phase separation that scatters light off the domain structure. Even when the materials that make up the two domains are similar in index of refraction, small differences normally create a hazy or translucent appearance. It has been discovered, however, that the incorporation of a solid structural polymer with T_{g} above room temperature (such as polycarbonate), along with a transport phase, creates transparent and stain-resistant polymers with 1000× greater transport of antimicrobial agents compared to single phase-coatings.

Some variations utilize polymeric coatings that are solid but have fast transport rates of antimicrobial agents, enabled by a two-phase architecture with a discrete solid structural phase combined with an antimicrobial-containing continuous transport phase that is phase-separated with the discrete solid structural phase.

In this patent application, “fast transport” means a specific conductivity of at least 10⁻⁵ mS/cm. “Antimicrobial agents” or synonymously “antimicrobial actives” include germicides, bactericides, virucides (antivirals), antifungals, antiprotozoals, antiparasites, and biocides. In some embodiments, antimicrobial agents are specifically bactericides, such as disinfectants, antiseptics, and/or antibiotics. In some embodiments, antimicrobial agents are specifically virucides, or include virucides.

Some embodiments overcome the conventional trade-off between antifouling and fluorinated material content. Fluorinated materials are usually employed in order to reject stains and fluids. By contrast, the structure disclosed herein employs a biphasic polymer with one component (the solid structural polymer) having a glass-transition temperature above the use temperature. The crystallized nature of the solid structural polymer being below its T_{g} results in the material not being penetrated by stains. A second phase, which is a continuous transport phase, enables removal of stains on the surface.

Some embodiments overcome the conventional trade-off between transport of absorbed molecules and transparency. Phase separation of 0.1-500 μm results in up to 1000× faster diffusion compared to nanoscale (<100 nm) phase separation. Fast transport of antimicrobial agents is retained without creating an optically opaque antimicrobial structure. A structural phase with a T_{g} above room temperature inhibits surface staining.

Some variations utilize an antimicrobial structure comprising:

(a) a discrete solid structural phase comprising a solid structural polymer, wherein the solid structural polymer is characterized by a glass-transition temperature from about 25° C. to about 300° C.;

(b) a continuous transport phase that is interspersed within the discrete solid structural phase, wherein the continuous transport phase comprises a solid transport material; and

(c) an antimicrobial agent contained within the continuous transport phase, wherein the antimicrobial agent is at least partially dissolved in a fluid and/or wherein the antimicrobial agent is in a solid solution with the continuous transport phase,

wherein the discrete solid structural phase and the continuous transport phase are separated by an average phase-separation length selected from about 100 nanometers to about 500 microns.

The glass-transition temperature T_{g} of a material characterizes temperatures at which a glass transition is observed. A glass transition is the gradual and reversible transition in amorphous materials (or in amorphous regions within semicrystalline materials) from a hard and relatively brittle “glassy” state into a viscous or rubbery state as the temperature is increased. A glass transition generally occurs over a temperature range and depends on the thermal history; therefore, a test method needs to be defined in order to ascertain a value of T_{g} for a given material.

In this patent application, the glass-transition temperature T_{g} is measured according to the equal-areas method described in International Standard ISO 11357-2, “Plastics—Differential scanning calorimetry (DSC)—Part 2: Determination of glass transition temperature and step height”, Third Edition, March 2020, which is hereby incorporated by reference. The measurement of T_{g} uses the energy release on heating in differential scanning calorimetry (DSC). The change in heat flow rate as a function of temperature is recorded and the glass-transition temperature and step height are determined from the curve thus obtained. The glass transition is assigned to the temperature obtained by drawing a vertical line such that the areas between DSC trace and baselines below and above the curve are equal.

As the glass transition is a kinetic phenomenon, the glass-transition temperature depends on the actual cooling rate and annealing conditions below T_{g}. Unperturbed glass transitions are obtained only if cooling and subsequent heating rate are the same and no significant physical aging occurs due to annealing below T_{g}. If a sample is cooled significantly slower or annealed below T_{g}, enthalpy relaxations can occur, resulting in endotherm peaks just above T_{g}. Peaks due to enthalpy relaxation will disappear by extrapolating to zero heating rates. The equal-areas method provides the best procedure to obtain an accurate T_{g} in the case of occurrence of enthalpy relaxations. The equal-areas method is described in section 10.1.2 of ISO 11357-2, which is hereby incorporated by reference.

Examples of polymers with T_{g}<25° C. include silicones, polyvinylidene fluoride, polyvinyl fluoride, polychloroprene, polyethylene, polypropylene, and poly(butyl acrylate). Many examples of polymers with T_{g}≥25° C. are provided below.

The requirement of T_{g}≥25° C. is based on the use temperature of the antimicrobial structure being about 25° C. If the use temperature is higher, such as 40° C., then the T_{g} of the solid structural polymer may be about 40° C. or higher. Likewise, in certain situations where the antimicrobial-structure use temperature is lower, such as 0° C., then the T_{g} of the solid structural polymer may be about 0° C. or higher.

In various embodiments, the glass-transition temperature T_{g} of the solid structural polymer is about, at least about, or at most about 25° C., 30° C., 35° C., 40° C., 45° C., 50° C., 60° C., 70° C., 80° C., 90° C., 100° C., 110° C., 120° C., 130° C., 140° C., 150° C., 160° C., 170° C., 180° C., 190° C., 200° C., 210° C., 220° C., 230° C., 240° C., 250° C., 260° C., 270° C., 280° C., 290° C., or 300° C., including any intervening ranges (e.g., T_{g}=30-150° C., T_{g}=50-200° C., etc.). Reference to a range of T_{g} means that a solid structural polymer may be selected such that its single value of T_{g}, measured pursuant to ISO 11357-2, falls within the specified range.

In some embodiments, a high glass-transition temperature (i.e., T_{g}≥25° C.) of the solid structural polymer improves the anti-fouling performance of the antimicrobial structure (e.g., a coating). Structural phases such as poly(butadiene) or poly(tetrahydrofuran) have T_{g}<25° C. and typically require at least 10 vol % of a fluorinated polyol added to the structural phase to reject stains. Non-fluorinated solid structural polymers resist penetration of external soils into the coating, such as a fluorine-free anti-fouling coating.

A crosslinking molecule may also function as a chain extender. Alternatively, or additionally, a separate chain extender may be used. In some embodiments, a crosslinking molecule or chain extender is selected from polyol or polyamine crosslinkers or chain extenders that possess a functionality of 2, 3, or greater. In various embodiments, polyol or polyamine crosslinkers or chain extenders are selected from the group consisting of 1,3-butanediol, 1,4-butanediol, 1,3-propanediol, 1,2-ethanediol, diethylene glycol, triethylene glycol, tetraethylene glycol, propylene glycol, dipropylene glycol, tripropylene glycol, neopentyl glycol, 1,6-hexanediol, 1,4-cyclohexanedimethanol, ethanol amine, diethanol amine, methyldiethanolamine, phenyldiethanolamine, glycerol, trimethylolpropane, 1,2,6-hexanetriol, triethanolamine, pentaerythritol propoxylate, ethylenediamine, 1,3-propanediamine, 1,4-butanediamine, diethyltoluenediamine, dimethylthiotoluenediamine, isophoronediamine, diaminocyclohexane, N,N,N′,N′-tetrakis(2-hydroxypropyl)ethylenediamine, and homologues, derivatives, or combinations thereof.

The average phase-separation length, between the discrete solid structural phase and the continuous transport phase, may vary widely. In some embodiments, the average phase-separation length is selected from about 100 nanometers to about 100 microns. In some embodiments, the average phase-separation length is selected from about 200 nanometers to about 50 microns. In some embodiments, the average phase-separation length is selected from about 1 micron to about 100 microns. In some embodiments, the average phase-separation length is selected from about 1 micron to about 50 microns. In various embodiments, the average phase-separation length is selected from about, at least about, or at most about 100 nm, 125 nm, 150 nm, 175 nm, 200 nm, 250 nm, 300 nm, 400 nm, 500 nm, 600 nm, 700 nm, 800 nm, 900 nm, 1 μm, 2 μm, 3 μm, 4 μm, 5 μm, 6 μm, 7 μm, 8 μm, 9 μm, 10 μm, 15 μm, 20 μm, 25 μm, 30 μm, 35 μm, 40 μm, 45 μm, 50 μm, 60 μm, 70 μm, 80 μm, 90 μm, 100 μm, 150 μm, 200 μm, 250 μm, 300 μm, 350 μm, 400 μm, 450 μm, or 500 μm, including any intervening ranges (e.g., 150 nm-5 μm, 500 nm-45 μm, etc.). There may be narrow or broad distribution of phase-separation lengths. Exemplary imaging techniques to measure phase separation include, but are not limited to, confocal laser scanning microscopy, scanning electron microscopy, scanning tunneling microscopy, and atomic force microscopy.

In some embodiments, the antimicrobial structure is transparent or partially transparent for optical frequencies of ordinary light. Transparent antimicrobial coatings are useful because they do not change the appearance of underlying substrates being coated (e.g., a door handle).

The optical transparency of the antimicrobial structure may be about, or at least about, 50%, 55%, 60%, 65%, 70%, 75%, 80%, 85%, 90%, 95%, or 99%, for example. In this disclosure, the optical transparency of an antimicrobial structure is the light transmittance, averaged across light wavelengths from 400 nm to 800 nm, through a 100-micron film of the antimicrobial structure at 25° C. and 1 bar. When the antimicrobial structure has a transparency less than 50%, the structure may be characterized as translucent.

The optical transparency of the antimicrobial structure is a function of the optical transparency of the individual components—the discrete solid structural phase, the continuous transport phase, the antimicrobial agent, and any other additives. Preferably, each component is at least partially transparent. Antimicrobial agent liquids or solutions are typically clear. When one component is relatively opaque, the overall antimicrobial structure may still have an acceptable transparency, depending on the amount of the relatively opaque component, for example.

In certain embodiments, different phases of the antimicrobial structure are selected such that the respective refraction indices are matched or substantially similar. One example is polytetrahydrofuran with poly(ethylene glycol), which are index-matched to within about 1%. Another example is polytetrahydrofuran with poly(propylene glycol), which are index-matched to within 2%. Another example is polycarbonate with poly(ethylene glycol), which are index-matched to within 10%. In some embodiments, the continuous transport phase and the discrete solid structural phase are selected such that the index of refraction matches to within ±10%, preferably within ±5%, more preferably with ±2%, and most preferably with ±1%. Note, however, that refractive-index matching is not a requirement of the present invention.

The optical transparency of the antimicrobial structure may temporarily deviate from its initial value when dirt or debris contaminates the surface, before the surface is wiped or cleaned. The antifouling nature of certain antimicrobial structures can be important to avoid permanent decrease in optical transparency in the case of non-cleanable fouling.

In some embodiments, the antimicrobial structure is characterized in that the antimicrobial agent has a diffusion coefficient from about 1018 m²/s to about 10⁻⁹ m²/s, measured at 25° C. and 1 bar, within the continuous transport phase. In certain embodiments, the antimicrobial agent has a diffusion coefficient from about 10⁻¹⁶ m²/s to about 10⁻¹¹ m²/s, measured at 25° C. and 1 bar, within the continuous transport phase. In various embodiments, the antimicrobial agent has a diffusion coefficient, measured at 25° C. and 1 bar, within the continuous transport phase, of about, or at least about 10⁻¹⁷ m²/s, 10⁻¹⁶ m²/s, 10⁻¹⁵ m²/s, 10⁻¹⁴ m²/s, 10⁻¹³ m²/s, 10⁻¹² m²/s, 10⁻¹¹ m²/s, 10⁻¹¹ m²/s, or 10⁻⁹ m²/s, including any intervening ranges.

In some antimicrobial structures, there are electrodes embedded within the antimicrobial structure, and the antimicrobial agent is electrically or electrochemically rechargeable. For example, the antimicrobial agent may be hypochlorite, hypochlorous acid, hydrogen peroxide, or a combination thereof, wherein the electrodes are configured to generate the antimicrobial agent in situ. These electrodes are distinct from the antimicrobial-agent sensor.

Some embodiments provide an antimicrobial structure comprising:

(a) a discrete solid structural phase comprising a solid structural material;

(b) a continuous transport phase that is interspersed within the discrete solid structural phase, wherein the continuous transport phase comprises a solid transport material;

(c) a continuous transport phase containing an antimicrobial agent and a transport-phase liquid that at least partially dissolves the antimicrobial agent; and

(d) first and second electrodes,

wherein the antimicrobial agent is electrically or electrochemically rechargeable when a voltage is applied between the first and second electrodes,

and wherein the discrete solid structural phase and the continuous transport phase are separated by an average phase-separation length from about 100 nanometers to about 500 microns.

In some embodiments, the first and second electrodes are embedded within the discrete solid structural phase. In some embodiments, at least one of the first and second electrodes is an outer layer disposed on the discrete solid structural phase. In some embodiments, the first electrode is a first outer layer disposed on the discrete solid structural phase, and the second electrode is a second outer layer disposed on the discrete solid structural phase. In some embodiments, one of the first and second electrodes is integrated with a base substrate or a wall. One or both of the first and second electrodes may have a non-planar electrode architecture. The electrodes may be fabricated from metal, carbon, or other electrically conductive materials, in the form of grids, meshes, or perforated plates, or other configurations that are electrochemically stable. In certain embodiments, the electrodes contain a catalyst, such as forming a coating an electrode surface, or as the entire electrode material. The catalyst may be selected from the group consisting of Ti, Pt, Ru, Ir, Ta, Rh, Pd, Ag, oxides thereof, or a combination of the foregoing, for example.

An antimicrobial structure with embedded electrodes may be used in a method of charging or recharging the antimicrobial structure with an antimicrobial agent, the method comprising:

(i) providing an antimicrobial structure comprising: a discrete solid structural phase comprising a solid structural material; a continuous transport phase that is interspersed within the discrete solid structural phase, wherein the continuous transport phase comprises a solid transport material; and first and second electrodes;

(ii) introducing an antimicrobial agent precursor to the continuous transport phase; and

(iii) applying a voltage between the first and second electrodes, wherein the antimicrobial agent precursor is electrochemically converted to an antimicrobial agent within the continuous transport phase.

The method may be used to initially charge the antimicrobial agent into the antimicrobial structure. Also, the method may be used to recharge the antimicrobial agent into the antimicrobial structure after a period of use.

In some embodiments, step (ii), the continuous transport phase is wet with a liquid solution containing the antimicrobial agent precursor and/or a liquid electrolyte containing the antimicrobial agent precursor. The antimicrobial agent precursor may be sodium chloride, converting to sodium hypochlorite and/or hypochlorous acid as the antimicrobial agent. The antimicrobial agent precursor may be sodium hypochlorite and/or hypochlorous acid, converting to chlorine-containing N-halamines as the antimicrobial agent, for example. The antimicrobial agent precursor may be water, converting to hydrogen peroxide (H₂O₂) as the antimicrobial agent, for example.

The antimicrobial structure may further contain one or more additives selected from the group consisting of buffers, UV stabilizers, fillers, pigments, flattening agents, flame retardants, salts, surfactants, dispersants, defoamers, wetting agents, antioxidants, and combinations thereof, for example. Additives are further discussed later in this specification.

In certain embodiments, the entire antimicrobial structure is non-fluorinated, i.e., contains essentially no fluorine. The entire antimicrobial structure includes the discrete solid structural phase, the continuous transport phase, the antimicrobial agent, crosslinking agents, chain extenders, other additives, etc.

In some embodiments, the antimicrobial structure further contains one or more protective layers. Typically, the protective layers are disposed on the outside of the antimicrobial structure, protecting the structure from the environment. A protective layer may be fabricated from polyurethanes, silicones, epoxy-amine materials, polysulfides, natural or synthetic rubber, fluoropolymers, or combinations thereof, for example.

The antimicrobial structure may be a coating or may be present in a coating. The antimicrobial structure may be present at a surface of a bulk object.

Additional variations of the present disclosure will now be described, without limiting the scope of the invention defined by the claims.

The disclosed biphasic polymer is capable of resolving the technical trade-offs between antimicrobial solutions and solid surfaces. Conventional liquid solutions are fast but not persistent. Liquid solutions can reduce the population of bacteria and viruses on a timescale of minutes, but the liquid solutions do not stay on surfaces and have a one-time effect. Conventional solid antimicrobial surfaces reduce bacteria and virus populations quite slowly, causing bacteria and virus to remain on surfaces for extended times. See Behzadinasab et al., “A Surface Coating that Rapidly Inactivates SARS-CoV-2”, ACS Appl. Mater. Interfaces 2020, 12, 31, as an example of an antimicrobial coating that requires at least 1 hour for effectiveness. The slow activity of conventional solid antimicrobial materials is due to the time needed for antimicrobial agents to diffuse to the surface. These surfaces also fail to work if they are dirty, because soil blocks the transport of antimicrobial agents to the surface.

By contrast, the biphasic polymer disclosed herein breaks the trade-off between activity and persistence. The discrete solid structural phase provides persistence on a surface while the continuous transport phase allows antimicrobial agents to move to microbes (e.g., viruses or bacteria) on the surface at order-of-magnitude faster rates than is possible with diffusion through a single solid material. A biphasic structure simultaneously provides durability and fast transport to the surface where antimicrobial agents can kill or deactivate microbes at the surface. The continuous transport phase may contain an aqueous or non-aqueous solvent or electrolyte to further enhance transport rates of antimicrobial agents. In some embodiments, the continuous transport phase passively absorbs water from the environment, which water may enhance transport rates of antimicrobial agents and/or improve the effectiveness of the antimicrobial agents.

Some variations utilize an antimicrobial structure intended to contain an antimicrobial-agent sensor, the antimicrobial structure comprising:

(a) a discrete solid structural phase comprising a solid structural material;

(b) a continuous transport phase that is interspersed within the discrete solid structural phase, wherein the continuous transport phase comprises a solid transport material; and

(c) an antimicrobial agent contained within the continuous transport phase, wherein the discrete solid structural phase and the continuous transport phase are separated by an average phase-separation length from about 100 nanometers to about 500 microns.

Certain variations utilize an antimicrobial structure intended to contain an antimicrobial agent as well as an antimicrobial-agent sensor, the antimicrobial structure comprising:

(a) a discrete solid structural phase comprising a solid structural material;

(b) a continuous transport phase that is interspersed within the discrete solid structural phase, wherein the continuous transport phase comprises a solid transport material, and wherein the continuous transport phase is capable of containing an antimicrobial agent (such as at a time of intended use or regeneration), wherein the discrete solid structural phase and the continuous transport phase are separated by an average phase-separation length from about 100 nanometers to about 500 microns.

In some embodiments, the continuous transport phase is a solid solution or solid suspension of the solid transport material and the antimicrobial agent. For example, when the antimicrobial agent is a liquid, the continuous transport phase may be a solution of the solid transport material and the antimicrobial agent. When the antimicrobial agent is a solid, the continuous transport phase may be a suspension of the solid transport material and the antimicrobial agent. In certain embodiments, the solid transport material and the antimicrobial agent form a true solid solution, which means that each material is dissolved in the other material such that a single solid phase results.

In other embodiments, the continuous transport phase contains a transport-phase liquid that at least partially dissolves the antimicrobial agent. The transport-phase liquid may be selected from the group consisting of water, dialkyl carbonate, propylene carbonate, γ-butyrolactone, 2-phenoxyethanol, and combinations thereof.

Alternatively, or additionally, the transport-phase liquid is selected from polar solvents. Polar solvents may be protic polar solvents or aprotic polar solvents. Exemplary polar solvents include, but are not limited to, water, alcohols, ethers, esters, ketones, aldehydes, carbonates, and combinations thereof. In some embodiments, the transport-phase liquid is water that is passively incorporated from atmospheric humidity.

Alternatively, or additionally, the transport-phase liquid is selected from ionic liquids. Exemplary ionic liquids include, but are not limited to, ammonium-based ionic liquids synthesized from substituted quaternary ammonium salts.

In some embodiments, the antimicrobial agent is selected from quaternary ammonium molecules (whether or not classified as an ionic liquid). Exemplary quaternary ammonium molecules include, but are not limited to, benzalkonium chloride, benzethonium chloride, methylbenzethonium chloride, cetalkonium chloride, cetylpyridinium chloride, cetrimonium, cetrimide, tetraethylammonium bromide, didecyldimethylammonium chloride, dioctyldimethylammonium chloride, and domiphen bromide. Quaternary ammonium molecules or eutectic mixtures of quaternary ammonium molecules that are liquids at room temperature-ionic liquids or ionic liquid eutectics, respectively-enable liquid-state rates of transport with negligible vapor pressure. A specific example is tetrabutylammonium heptadecafluorooctanesulfonate (C₂₄H₃₆F₁₇NO₃S), which has a melting point <5° C. Another specific example is tetraoctylammonium chloride (C₃₂H₆₈ClN) with a melting point of 50-54° C. mixed with tetraheptylammonium chloride (C₂₈H₆₀ClN) with a melting point of 38-41° C. in a eutectic composition ratio that forms a liquid at room temperature (25° C.). Quaternary ammonium molecules may be mixed with imidazolium-based ionic liquids, pyridinium-based ionic liquids, pyrrolidinium-based ionic liquids, and/or phosphonium-based ionic liquids.

In certain embodiments, the transport-phase liquid contains one or more water-soluble salts, one or more of which may function as an antimicrobial agent. Exemplary water-soluble salts include, but are not limited to, copper chloride, copper nitrate, zinc chloride, zinc nitrate, silver chloride, silver nitrate, or combinations thereof. Other exemplary water-soluble salts include quaternary ammonium salts, such as (but not limited to) the quaternary ammonium molecules recited above.

In certain embodiments, the transport-phase liquid is a eutectic liquid salt, which is optionally derived from ammonium salts. The eutectic liquid salt may contain an antimicrobial agent or may itself be antimicrobially active.

In some embodiments, the antimicrobial agent is selected from oxidizing molecules, such as (but not limited to) those selected from the group consisting of sodium hypochlorite, calcium hypochlorite, hypochlorous acid, hydrogen peroxide, and combinations thereof.

In some embodiments, the antimicrobial agent is selected from metal ions, such as (but not limited to) silver, copper, zinc, cobalt, nickel, or combinations thereof. Any metal ion with at least some antimicrobial activity itself, or which confers antimicrobial activity to a compound which the metal ion binds to, may be employed. The metal ion may be present in a metal complex or a metal salt, for example. Metal ions may be present in oxides. In certain embodiments, the antimicrobial agent contains a neutral metal (e.g., zero-valent silver, copper, or zinc) which may be dissolved in a liquid and/or may be present as nanoparticles, for example.

An electrolyte may be included in the continuous transport phase, such as to increase transport rates of the antimicrobial agent.

An exemplary electrolyte is a complex formed between poly(ethylene oxide) and metal salts, such as poly(ethylene oxide)-Cu(CF₃SO₃)₂ which is a known copper conductor. Cu(CF₃SO₃)₂ is the copper(II) salt of trifluoromethanesulfonic acid. See Bonino et al., “Electrochemical properties of copper-based polymer electrolytes”, Electrochimica Acta, Vol. 37, No. 9, Pages 1711-1713 (1992), which is incorporated by reference.

When an electrolyte is included in the continuous transport phase, one or more solvents for the electrolyte may be present. Solvents for the electrolyte may be selected from the group consisting of sulfoxide, sulfolane, ethylene carbonate, propylene carbonate, dimethyl carbonate, diethyl carbonate, methyl ethyl carbonate, 1,2-dimethoxyethane, 1,2-diethoxyethane, γ-buterolactone, γ-valerolactone, 1,3-dioxolane, tetrahydrofuran, 2-methyltetrahydrofuran, acetonitrile, proprionitrile, diglyme, triglyme, methyl formate, trimethyl phosphate, triethyl phosphate, and mixtures thereof, for example.

When an electrolyte is included in the continuous transport phase, there may be a salt within an aqueous or non-aqueous solvent. Exemplary salts are salts of transition metals (e.g., V, Ti, Cr, Co, Ni, Cu, Zn, Tb, W, Ag, Cd, or Au), salts of metalloids (e.g., Al, Ga, Ge, As, Se, Sn, Sb, Te, or Bi), salts of alkali metals (e.g., Li, Na, or K), salts of alkaline earth metals (e.g., Mg or Ca), or a combination thereof.

In some embodiments, a gel electrolyte is included in the continuous transport phase. A gel electrolyte contains a liquid electrolyte including an aqueous or non-aqueous solvent as well as a salt, in a polymer host. The solvent and salt may be selected from the lists above. The polymer host may be selected from the group consisting of poly(ethylene oxide), poly(vinylidene fluoride), poly(acrylonitrile), poly(methyl methacrylate), poly(vinylidene fluoride-hexafluoropropylene) (PVdF-co-HFP), polycarbonate, polysiloxane, and combinations thereof.

N-halamines may be incorporated into the backbone of the biphasic polymer (in the structural phase, the transport phase, or both phases). N-halamines are compounds that stabilize an oxidizing agent (such as chlorine contained within the N-halamine molecule) and may be used to kill or deactivate microbes. N-halamines remain stable over long time periods and may be recharged by exposure to an oxidizer such as dilute bleach or ozone. Exemplary N-halamines include, but are not limited to, hydantoin (imidazolidine-2,4-dione); 1,3-dichloro-5,5-dimethylhydantoin; 3-bromo-1-chloro-5,5-dimethylhydantoin; 5,5-dimethylhydantoin; 4,4-dimethyl-2-oxazalidinone; tetramethyl-2-imidazolidinone; and 2,2,5,5-tetramethylimidazo-lidin-4-one. Examples of antimicrobial N-halamines are also disclosed in Lauten et al., Applied and Environmental Microbiology Vol. 58, No. 4, Pages 1240-1243 (1992), which is incorporated by reference.

In certain embodiments, the antimicrobial structure further contains one or more layers of an antimicrobial-agent storage phase that is distinct from the continuous transport phase and the discrete solid structural phase. In these or other certain embodiments, the antimicrobial structure further contains inclusions of an antimicrobial-agent storage phase that is distinct from the continuous transport phase and the discrete solid structural phase. An antimicrobial-agent storage phase may be fabricated from the same material as the solid transport material, or from a different material. For example, both the solid transport material and the antimicrobial-agent storage phase (when present) may be made from a hydrophobic, non-lipophobic polymer. The antimicrobial-agent storage phase may contain an antimicrobial agent that is released initially, continuously, or periodically into the continuous transport phase.

The antimicrobial structure may further contain one or more additives, such as (but not limited to) salts, buffers, UV stabilizers, particulate fillers, pigments, flattening agents, surfactants, dispersants, flame retardants, or combinations thereof. Additives, when present, may be incorporated into the discrete solid structural phase, the continuous transport phase, both of these phases, or neither of these phases but within a separate phase.

When an additive is a salt, there will be a cation and anion forming the salt. The cation element may be Li, Na, K, Mg, and/or Ca, for example. The anion element or group may be F, Cl, Br, I, SO₃, SO₄, NO₂, NO₃, CH₃COO, and/or CO₃, for example.

When an additive is a buffer, it may be an inorganic or organic molecule that maintains a pH value or pH range via acid-base reactions. A buffer may be discrete or may be bonded to the solid transport material, for example.

When an additive is a UV stabilizer, it may be an antioxidant (e.g., a thiol), a hindered amine (e.g., a derivative of tetramethylpiperidine), UV-absorbing nanoparticles (e.g., TiO₂, ZnO, CdS, CdTe, or ZnS—Ag nanoparticles), or a combination thereof, for example.

When an additive is a particulate filler, it may be selected from the group consisting of silica, alumina, silicates, talc, aluminosilicates, barium sulfate, mica, diatomite, calcium carbonate, calcium sulfate, carbon, wollastonite, and a combination thereof, for example. A particulate filler is optionally surface-modified with a compound selected from the group consisting of fatty acids, silanes, alkylsilanes, fluoroalkylsilanes, silicones, alkyl phosphonates, alkyl phosphonic acids, alkyl carboxylates, alkyldisilazanes, and combinations thereof, for example.

When an additive is a pigment, it may be selected from the group consisting of metal-complex pigments, azo pigments, polycyclic pigments, and anthraquinone pigments. Metal-oxide pigments include titanium dioxide, cobalt oxide, and iron oxide, for example.

When an additive is a flame retardant for the suppression of flammability (e.g., to inhibit flame propagation), the flame retardant may be selected from the group consisting of ammonium salts, phosphate salts, phosphines, halogenated compounds, carbonate salts, hydroxide salts, borate salts, high-surface-area silicas, expandable graphite, and combinations thereof. Specific examples of flame retardants are ammonium polyphosphate, magnesium hydroxide, zinc hydroxystannate, antimony trioxide, magnesium hydroxycarbonate, zinc borate, magnesium aluminum hydroxycarbonate, aluminum trihydroxide, tetrabromobisphenol A, tetrabromobisphenol A bis(2,3-dibromopropyl ether), bisphenol-A bis(diphenyl phosphate), brominated polyols, melamine resins, chlorinated paraffins, and combinations thereof.

A suitable antimicrobial agent may be electrochemically charged or recharged (e.g. after a period of use). In rechargeable configurations, the continuous transport phase will typically be wet with a liquid solution containing water or another solvent, and/or a liquid electrolyte (optionally, a gel electrolyte). The liquid solution contains an antimicrobial agent or a precursor to an antimicrobial agent. The liquid solution may contain a salt and/or a pH buffer as well. For example, when the selected antimicrobial agent is sodium hypochlorite (NaOCl) and/or hypochlorous acid (HOCl), sodium chloride (NaCl) may be used as an antimicrobial agent precursor. A periodic wash or soak with a salt solution and buffer may be used to maintain pH. The salt (e.g., NaCl) solution of a periodic wash or soak may be at a salt concentration from about 200 ppm to about 50,000 ppm, such as from about 1,000 ppm to about 10,000 ppm, for example. A periodic soak with a liquid electrolyte may be used to enhance transport rates of the antimicrobial agent or precursor thereof.

As another example, the antimicrobial structure may be configured to generate hydrogen peroxide. Electrochemical methods to generate hydrogen peroxide and catalysts are described in Perry et al., “Electrochemical synthesis of hydrogen peroxide from water and oxygen”, Nature Reviews Chemistry volume 3, pages 442-458 (2019), which is hereby incorporated by reference for its teachings of both methods and catalysts. H₂O₂ can form at an electrode by oxidizing H₂O and/or by partially reducing O₂. One or both electrodes may contain catalysts for electrochemical formation of hydrogen peroxide from water oxidation including metal alloys (PdₓAu₁₋ₓ, 0<x<1), carbon, doped carbon (e.g., B-doped C), metal oxides (e.g., SnO₂ or MnOₓ, x=1-3.5), BiVO₄, and TiO₂.

The antimicrobial structure may further contain one or more protective layers, such as environmentally protective layer(s). Thus the antimicrobial structure may be a multilayer structure, which may contain two layers, three layers, four layers, or more. In some embodiments, there is an outer layer to seal the active components from the environment while retaining and diffusing antimicrobial agents over time.

There may be one or more capping layers that protect a liquid-like layer underneath a capping layer, reducing evaporation of liquids. In these embodiments, microbes (e.g., bacteria or viruses) may enter through a capping layer to reach the antimicrobial agent under the capping layer. Alternatively, or additionally, microbes may remain on the capping layer and antimicrobial agent diffuses through the capping layer to reach the microbes.

In certain embodiments, the antimicrobial structure contains a porous top layer and an absorbing inner layer that contains antimicrobial agents. In these embodiments, the porous top layer may include a material such as expanded polytetrafluoroethylene (e.g., Gore-Tex®), which allows vapor but not liquid to be exchanged. A bottom sealing layer may be incorporated to prevent the loss of the antimicrobial agents.

In certain embodiments, the antimicrobial structure includes a multi-layer sub-structure wherein at least one layer contains the biphasic architecture as disclosed herein, and wherein an internal or encapsulated layer contains antimicrobial agents and/or preferentially traps microbes to enhance antimicrobial effectiveness.

The antimicrobial structure disclosed herein is not limited to transport of antimicrobial agent exclusively by pure diffusion. Depending on the specific choice of materials, antimicrobial agent, and method of using the structure, the actual transport may occur by various mass-transfer mechanisms including, but not limited to, Fickian diffusion, non-Fickian diffusion permeation, sorption transport, solubility-diffusion, charge-driven flow, convection, capillary-driven flow, and so on. As just one example, when the antimicrobial structure is employed in an automobile, the structure can move around quickly in space such that the antimicrobial agent undergoes some amount of centrifugal convection.

Even when the mass transport is dominated by diffusion, the actual transport rate (flux) of antimicrobial agent through the structure depends not only on the diffusion coefficient, but also on the three-dimensional concentration gradient, temperature, and possibly other factors such as pH. In various embodiments, the actual flux of antimicrobial agent through the structure is about, or at least about, 2×, 3×, 4×, 5×, 10×, 20×, 30×, 40×, 50×, 100×, 200×, 300×, 400×, 500×, or 1000× higher than the flux through a solid-state material. A person of ordinary skill in the art can calculate or estimate transport fluxes for a given structure geometry and materials, or carry out experiments to determine such fluxes.

The antimicrobial structure may be characterized by an original concentration of antimicrobial agent (prior to exposure to microbes). The original concentration of antimicrobial agent may be selected based on the type of antimicrobial agent, and intended use of the antimicrobial structure, and/or other factors. In various embodiments, the original concentration of antimicrobial agent is about, at least about, or at most about 0.00001 wt %, 0.0001 wt %, 0.001 wt %, 0.01 wt %, 0.1 wt %, 1 wt %, 5 wt %, 10 wt %, 20 wt %, 30 wt %, 40 wt %, or 50 wt %, on the basis of mass of antimicrobial agent divided by total mass of all components within 0.1%, 1%, 5%, or 10% depth from the surface into the bulk structure.

In some embodiments, the sensing system is used to determine whether the antimicrobial agent needs to be replenished into the antimicrobial structure. For example, the antimicrobial agent may be replenished on an outer surface of the antimicrobial structure to at least 25% of the original concentration of antimicrobial agent, in 100 minutes or less. In various embodiments, the antimicrobial agent is replenished on an outer surface of the antimicrobial structure to at least 30%, 40%, 50%, 60%, 70%, 75%, 80%, 85%, 90%, 95%, 99%, 99.9%, or 100% of the original concentration of antimicrobial agent, in 100 minutes or less. In these or other embodiments, the antimicrobial agent is replenished on an outer surface of the antimicrobial structure to at least 25% of the original concentration of antimicrobial agent, in 90, 80, 70, 60, 50, 40, 30, 20, 15, 10, 5, 4, 3, 2, or 1 minutes or less. Preferably, the antimicrobial agent is replenished on an outer surface of the antimicrobial structure to at least 50% of the original concentration of antimicrobial agent, in 60, 30, 20, 15, 10, 5, 4, 3, 2, or 1 minutes or less.

The antimicrobial structure may be a coating or may be present in a coating. Alternatively, or additionally, the antimicrobial structure may be present at a surface of a bulk object. The antimicrobial structure may be the entirety of a bulk object, with no underlying substrate or other solid structure.

In a commercial example, the antimicrobial structure is a coating disposed on an automotive dash board. In another commercial example, the antimicrobial structure is a coating disposed on an overhead stowage bin in an aerospace cabin.

The discrete solid structural phase may be fabricated from, or include, an anti-fouling polymer to minimize the presence of dirt and debris (e.g., oil) and to make the surface easier to clean. An exemplary anti-fouling polymer is a segmented copolymer, which is further described below.

The antimicrobial agent may be included in a coating precursor or may be applied to a coating through a soaking process, for example. In some embodiments, an antimicrobial agent is incorporated into the continuous transport phase during synthesis of the antimicrobial structure. In certain embodiments, an antimicrobial agent is incorporated into the continuous transport phase following synthesis of the antimicrobial structure, such as by infiltrating a liquid containing the antimicrobial agent into the continuous transport phase, or by electrochemically creating the antimicrobial agent in situ using a voltage applied between electrodes, for example.

Some embodiments are premised on the recognition that the sensor may be operated in reverse to detect the efficiency of replenishment of antimicrobial agent into a biphasic polymer, rather than the elution of antimicrobial agent out of a biphasic polymer.

Some variations provide a system configured to add an antimicrobial agent to a polymer, the system comprising:

(a) a polymer containing (i) a discrete solid structural phase comprising a solid structural polymer and (ii) a continuous transport phase comprising a solid transport polymer, wherein the continuous transport phase is capable of containing the antimicrobial agent; and

(b) an antimicrobial-agent sensor that chemically senses the antimicrobial agent, wherein the antimicrobial-agent sensor is disposed on a surface of, and in mass transport with, the polymer,

wherein the antimicrobial-agent sensor contains a responsive material disposed on or within a carrier material,

wherein the responsive material is chemically and reversibly reactive with the antimicrobial agent, and

wherein the responsive material exhibits an observable and quantifiable property change upon chemically releasing the antimicrobial agent in the reverse of a reaction between the responsive material and the antimicrobial agent.

Some embodiments will now be further described in reference to exemplary synthesis of a discrete solid structural phase and a continuous transport phase, a preferred biphasic architecture, and selective incorporation of an antimicrobial agent within the continuous transport phase.

Some embodiments preferentially incorporate an antimicrobial agent within one phase of a multiphase polymer coating. The structure of a microphase-separated polymer network provides a reservoir for antimicrobial agents within the continuous phase.

As intended herein, “microphase-separated” means that the first and second solid materials (e.g., soft segments) are physically separated on a microphase-separation length scale from about 0.1 microns to about 500 microns.

Unless otherwise indicated, all references to “phases” in this patent application are in reference to solid phases or fluid phases. A “phase” is a region of space (forming a thermodynamic system), throughout which all physical properties of a material are essentially uniform. Examples of physical properties include density and chemical composition. A solid phase is a region of solid material that is chemically uniform and physically distinct from other regions of solid material (or any liquid or vapor materials that may be present). Solid phases are typically polymeric and may melt or at least undergo a glass transition at elevated temperatures. Reference to multiple solid phases in a composition or microstructure means that there are at least two distinct material phases that are solid, without forming a solid solution or homogeneous mixture.

In some embodiments, the antimicrobial agent is in a fluid. Preferably, the fluid is not solely in a vapor phase at 25° C., since vapor is susceptible to leaking from the structure. However, the fluid may contain vapor in equilibrium with liquid, at 25° C. Also, in certain embodiments, a fluid is in liquid form at 25° C. but at least partially in vapor form at a higher use temperature, such as 30° C., 40° C., 50° C., or higher.

By a liquid being “disposed in” a solid material, it is meant that the liquid is incorporated into the bulk phase of the solid material, and/or onto surfaces of particles of the solid material. The liquid will be in close physical proximity with the solid material, intimately and/or adjacently. The disposition is meant to include various mechanisms of chemical or physical incorporation, including but not limited to, chemical or physical absorption, chemical or physical adsorption, chemical bonding, ion exchange, or reactive inclusion (which may convert at least some of the liquid into another component or a different phase, including potentially a solid). Also, a liquid disposed in a solid material may or may not be in thermodynamic equilibrium with the local composition or the environment. Liquids may or may not be permanently contained in the structure; for example, depending on volatility or other factors, some liquid may be lost to the environment over time.

By “selectively” disposed in the continuous transport phase, or the “selectivity” into the continuous transport phase, it is meant that of the antimicrobial agent that is disposed within the structure overall, at least 51%, preferably at least 75%, and more preferably at least 90% of the antimicrobial agent is disposed in only the continuous transport phase. In various embodiments, the selectivity into the continuous transport phase is about, or at least about, 60%, 65%, 70%, 75%, 80%, 85%, 90%, 95%, 99%, or 100%.

In some embodiments, a liquid is added to a polymer such as by submerging and soaking into the polymer. In these embodiments, the liquid may be absorbed into a solid polymer. In certain embodiments, the liquid absorption swells a polymer, which means that there is an increase of volume of polymer due to absorption of the liquid. The liquid may be, but does not need to be, classified as a solvent for the solid polymer which it swells.

The phase-separated microstructure preferably includes discrete islands of one material (the discrete solid structural phase) within a continuous sea of the other material (the continuous transport phase). The continuous phase provides unbroken channels within the material for transport of mass and/or electrical charge.

In some embodiments, there are both phase-separated inclusions of the same chemical material, as well as physically and chemically distinct materials as additional inclusions.

The discrete solid structural phase and the continuous transport phase may be present as phase-separated regions of a copolymer, such as a block copolymer. As intended herein, a “block copolymer” means a copolymer containing a linear arrangement of blocks, where each block is defined as a portion of a polymer molecule in which the monomeric units have at least one constitutional or configurational feature absent from the adjacent portions. Segmented block copolymers are preferred, providing two (or more) phases. An exemplary segmented copolymer is a urethane-urea copolymer. In some embodiments, a segmented polyurethane includes a microphase-separated structure of fluorinated and non-fluorinated species.

In some embodiments, a segmented copolymer is employed in which first soft segments form a continuous matrix and second soft segments are a plurality of discrete inclusions. In other embodiments, the first soft segments are a plurality of discrete inclusions and the second soft segments form a continuous matrix.

Segmented copolymers are typically created by combining a flexible oligomeric soft segment terminated with an alcohol or amine reactive groups and a multifunctional isocyanate. When the isocyanate is provided in excess relative to the alcohol/amine reactive groups, a viscous prepolymer mixture with a known chain length distribution is formed. This can then be cured to a high-molecular-weight network through the addition of amine or alcohol reactive groups to bring the ratio of isocyanate to amine/alcohol groups to unity. The product of this reaction is a chain backbone with alternating segments: soft segments of flexible oligomers and hard segments of the reaction product of low-molecular-weight isocyanates and alcohol/amines.

Due to the chemical immiscibility of these two phases, the material typically phase-separates on the length scale of these individual molecular blocks, thereby creating a microstructure of flexible regions adjacent to rigid segments strongly associated through hydrogen bonding of the urethane/urea moieties. This combination of flexible and associated elements typically produces a physically crosslinked elastomeric material.

Some variations utilize a segmented copolymer composition comprising:

(a) one or more first soft segments selected from fluoropolymers having an average molecular weight from about 500 g/mol to about 20,000 g/mol, wherein the fluoropolymers are (α,ω)-hydroxyl-terminated, (α,ω)-amine-terminated, and/or (α,ω)-thiol-terminated;

(b) one or more second soft segments selected from polyesters or polyethers, wherein the polyesters or polyethers are (α,ω)-hydroxyl-terminated, (α,ω)-amine-terminated, and/or (α,ω)-thiol-terminated;

(c) one or more isocyanate species possessing an isocyanate functionality of 2 or greater, or a reacted form thereof; and

(d) one or more polyol or polyamine chain extenders or crosslinkers, or a reacted form thereof, wherein the first soft segments and the second soft segments may (in some embodiments) be microphase-separated on a microphase-separation length scale from about 0.1 microns to about 500 microns, and optionally wherein the molar ratio of the second soft segments to the first soft segments is less than 2.0.

In some embodiments, fluoropolymers are present in the triblock structure:

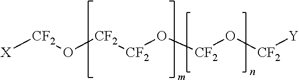

wherein:
X, Y=CH₂—(O—CH₂—CH₂)ₚ-T, and X and Y are independently selected;
p=1 to 50;
T is a hydroxyl, amine, or thiol terminal group;
m=0 to 100 (in some embodiments, m=1 to 100); and
n=0 to 100 (in some embodiments, n=1 to 100).

Some variations utilize a segmented copolymer composition comprising:

(a) one or more first soft segments selected from polycarbonates having an average molecular weight from about 500 g/mol to about 20,000 g/mol, wherein the polycarbonates are (α,ω)-hydroxyl-terminated, (α,ω)-amine-terminated, and/or (α,ω)-thiol-terminated;

(b) one or more second soft segments selected from polyesters or polyethers, wherein the polyesters or polyethers are (α,ω)-hydroxyl-terminated, (α,ω)-amine-terminated, and/or (α,ω)-thiol-terminated;

(c) one or more isocyanate species possessing an isocyanate functionality of 2 or greater, or a reacted form thereof; and

(d) one or more polyol or polyamine chain extenders or crosslinkers, or a reacted form thereof, wherein the first soft segments and the second soft segments may (in some embodiments) be microphase-separated on a microphase-separation length scale from about 0.1 microns to about 500 microns.

In some embodiments, the continuous transport phase includes a polyelectrolyte and a counterion to the polyelectrolyte. The polyelectrolyte may be selected from the group consisting of poly(acrylic acid) or copolymers thereof, cellulose-based polymers, carboxymethyl cellulose, chitosan, poly(styrene sulfonate) or copolymers thereof, poly(acrylic acid) or copolymers thereof, poly(methacrylic acid) or copolymers thereof, poly(allylamine), and combinations thereof, for example. The counterion may be selected from the group consisting of H⁺, Li⁺, Na⁺, K⁺, Ag⁺, Ca²⁺, Mg²⁺, La³⁺, C₁₆N⁺, F⁻, Cl⁻, Br⁻, I⁻, BF₄⁻, SO₄²⁻, PO₄²⁻, Cl₂SO₃⁻, and combinations thereof, for example.

Other ionic species, combined with counterions, may be employed as well in the continuous transport phase. Generally, in some embodiments, ionic species may be selected from the group consisting of an ionizable salt, an ionizable molecule, a zwitterionic component, a polyelectrolyte, an ionomer, and combinations thereof.

An “ionomer” is a polymer composed of ionomer molecules. An “ionomer molecule” is a macromolecule in which a significant (e.g., greater than 1, 2, 5, 10, 15, 20, or 25 mol %) proportion of the constitutional units have ionizable or ionic groups, or both.

The classification of a polymer as an ionomer versus polyelectrolyte depends on the level of substitution of ionic groups as well as how the ionic groups are incorporated into the polymer structure. For example, polyelectrolytes also have ionic groups covalently bonded to the polymer backbone, but have a higher ionic group molar substitution level (such as greater than 50 mol %, usually greater than 80 mol %). Polyelectrolytes are polymers whose repeating units bear an electrolyte group. Polyelectrolyte properties are thus similar to both electrolytes (salts) and polymers. Like salts, their solutions are electrically conductive. Like polymers, their solutions are often viscous.

In some embodiments, the continuous transport phase includes a polymer such as a polyurethane, a polyurea, a polysiloxane, or a combination thereof, with at least some charge along the polymer backbone. Polymer charge may be achieved through the incorporation of ionic monomers such as dimethylolpropionic acid, or another ionic species. The degree of polymer charge may vary, such as about, or at least about, 1, 2, 5, 10, 15, 20, or 25 mol % of the polymer repeat units being ionic repeat units.

In some embodiments, the continuous transport phase includes an ionic species selected from the group consisting of (2,2-bis-(1-(1-methyl imidazolium)-methylpropane-1,3-diol bromide), 1,2-bis(2′-hydroxyethyl)imidazolium bromide, (3-hydroxy-2-(hydroxymethyl)-2-methylpropyl)-3-methyl-1H-3?⁴-imidazol-1-ium bromide, 2,2-bis(hydroxymethyl)butyric acid, N,N-bis(2-hydroxyethyl)-2-aminoethanesulfonic acid, N-methyl-2,2′-iminodiethanol, 3-dimethylamino-1,2-propanediol, 2,2-bis(hydroxymethyl)propionic acid, 1,4-bis(2-hydroxyethyl)piperazine, 2,6-diaminocaproic acid, N,N-bis(2-hydroxyethyl)glycine, 2-hydroxypropanoic acid hemicalcium salt, dimethylolpropionic acid, N-methyldiethanolamine, N-ethyldiethanolamine, N-propyldiethanolamine, N-benzyldiethanolamine, N-t-butyldiethanolamine, bis(2-hydroxyethyl) benzylamine, bis(2-hydroxypropyl) aniline, and homologues, combinations, derivatives, or reaction products thereof.

A liquid may be introduced into the continuous transport phase actively, passively, or a combination thereof. In some embodiments, a liquid is actively introduced to the continuous transport phase by spraying of the liquid, deposition from a vapor phase derived from the liquid, liquid injection, bath immersion, or other techniques. In some embodiments, a liquid is passively introduced to the continuous transport phase by letting the liquid naturally be extracted from the normal atmosphere, or from a local atmosphere adjusted to contain one or more desired liquids in vapor or droplet (e.g., mist) form.

In certain embodiments, a desired additive is normally a solid at room temperature and is first dissolved or suspended in a liquid that is then disposed in the continuous transport phase.

In other certain embodiments, a desired additive is normally a solid at room temperature and is first melted to produce a liquid that is then disposed in the continuous transport phase. Within the continuous transport phase, the desired additive may partially or completely solidify back to a solid, or may form a multiphase material, for example.

Some potential additives contain reactive groups that unintentionally react with chemical groups contained in the polymer precursors. Therefore, in some cases, there exists an incompatibility of liquid species in the resin during chemical synthesis and polymerization. Addition of reactive fluid additives into the reaction mixture during synthesis can dramatically alter stoichiometry and backbone structure, while modifying physical and mechanical properties. One strategy to circumvent this problem is to block the reactive groups (e.g., alcohols, amines, and/or thiols) in the fluid additive with chemical protecting groups to render them inert to reaction with other reactive chemical groups (e.g., isocyanates) in the coating precursors.

In particular, it is possible to temporarily block a reactive position by transforming it into a new functional group that will not interfere with the desired transformation. That blocking group is conventionally called a “protecting group.” Incorporating a protecting group into a synthesis requires at least two chemical reactions. The first reaction transforms the interfering functional group into a different one that will not compete with (or compete at a lower reaction rate with) the desired reaction. This step is called protection. The second chemical step transforms the protecting group back into the original group at a later stage of synthesis. This latter step is called deprotection.

In some embodiments in which an additive contains alcohol, amine, and/or thiol groups, the additive thus contains chemical protecting groups to prevent or inhibit reaction of the alcohol, amine, and/or thiol groups with isocyanates. The protecting groups may be designed to undergo deprotection upon reaction with atmospheric moisture, for example.

In the case of an additive containing alcohol groups, the protecting groups may be selected from the silyl ether class of alcohol protecting groups. For example, the protecting groups may be selected from the group consisting of trimethylsilyl ether, isopropyldimethylsilyl ether, tert-butyldimethylsilyl ether, tert-butyldiphenylsilyl ether, tribenzylsilyl ether, triisopropylsilyl ether, and combinations thereof. In these or other embodiments, the protecting groups to protect alcohol may be selected from the group consisting of 2,2,2-trichloroethyl carbonate, 2-methoxyethoxymethyl ether, 2-naphthylmethyl ether, 4-methoxybenzyl ether, acetate, benzoate, benzyl ether, benzyloxymethyl acetal, ethoxyethyl acetal, methoxymethyl acetal, methoxypropyl acetal, methyl ether, tetrahydropyranyl acetal, triethylsilyl ether, and combinations thereof.

In the case of an additive containing amine groups, the protecting groups may be selected from the carbamate class of amine protecting groups, such as (but not limited to) vinyl carbamate. Alternatively, or additionally, the protecting groups may be selected from the ketamine class of amine protecting groups. In these or other embodiments, the protecting groups to protect amine may be selected from the group consisting of 1-chloroethyl carbamate, 4-methoxybenzenesulfonamide, acetamide, benzylamine, benzyloxy carbamate, formamide, methyl carbamate, trifluoroacetamide, tert-butoxy carbamate, and combinations thereof.

In the case of an additive containing thiol groups, the protecting groups may be selected from S-2,4-dinitrophenyl thioether and/or S-2-nitro-1-phenylethyl thioether, for example.

The typical reaction mechanism when water is the deprotecting reagent is simple hydrolysis. Water is often nucleophilic enough to kick off a leaving group and deprotect a species. One example of this is the protection of an amine with a ketone to form a ketamine. These can be mixed with isocyanates when the amine alone would react so quickly as to not be able to be practically mixed. Instead the ketamine reagent is inert but after mixing and casting as a film, atmospheric moisture will diffuse into the coating, remove the ketone (which vaporizes itself) and leaves the amine to rapidly react with neighboring isocyanates in situ.

Many deprotecting agents require high pH, low pH, or redox chemistry to work. However, some protecting groups are labile enough that water alone is sufficient to cause deprotection. When possible, a preferred strategy to spontaneously deprotect the molecules is through reaction with atmospheric moisture, such as an atmosphere containing from about 10% to about 90% relative humidity at ambient temperature and pressure. A well-known example is the room-temperature vulcanization of silicones. These systems have silyl ethers that are deprotected with moisture and in doing so the free Si—OH reacts with other silyl ethers to create Si—O—Si covalent bonds, forming a network.

In other embodiments, a chemical deprotection step is actively conducted, such as by introducing a deprotection agent and/or adjusting mixture conditions such as temperature, pressure, pH, solvents, electromagnetic field, or other parameters.

This specification hereby incorporates by reference herein Greene and Wuts, Protective Groups in Organic Synthesis, Fourth Edition, John Wiley & Sons, New York, 2007, for its teachings of the role of protecting groups, synthesis of protecting groups, and deprotection schemes including for example adjustment of pH by addition of acids or bases, to cause deprotection.

As intended in this patent application, “hygroscopic” means that a material is capable of attracting and holding water molecules from the surrounding environment. The water uptake of various polymers is described in Thijs et al., “Water uptake of hydrophilic polymers determined by a thermal gravimetric analyzer with a controlled humidity chamber” J. Mater. Chem., (17) 2007, 4864-4871, which is hereby incorporated by reference herein. In some embodiments, a hygroscopic material is characterized by a water absorption capacity, at 90% relative humidity and 30° C., of at least 5, 10, 15, 20, 25, 30, 35, 40, 45, or 50 wt % uptake of H₂O.

In some embodiments employing segmented copolymers, one of the first soft segments and second soft segments is oleophobic. An oleophobic material has a poor affinity for oils. As intended herein, the term “oleophobic” means a material with a contact angle of hexadecane greater than 90°. An oleophobic material may also be classified as lipophobic.

In some embodiments employing segmented copolymers, one of the first soft segments and the second soft segments may be a “low-surface-energy polymer” which means a polymer, or a polymer-containing material, with a surface energy of no greater than 50 mJ/m². In some embodiments, one of the first soft segments and the second soft segments has a surface energy from about 5 mJ/m² to about 50 mJ/m².

In some embodiments employing segmented copolymers, the first soft segments or the second soft segments may be or include a fluoropolymer, such as (but not limited to) a fluoropolymer selected from the group consisting of polyfluoroethers, perfluoropolyethers, fluoroacrylates, fluorosilicones, polytetrafluoroethylene (PTFE), polyvinylidene difluoride (PVDF), polyvinylfluoride (PVF), polychlorotrifluoroethylene (PCTFE), copolymers of ethylene and trifluoroethylene, copolymers of ethylene and chlorotrifluoroethylene, and combinations thereof.

In these or other embodiments, the first soft segments or the second soft segments may be or include a siloxane. A siloxane contains at least one Si—O—Si linkage. The siloxane may consist of polymerized siloxanes or polysiloxanes (also known as silicones). One example is polydimethylsiloxane.

In some embodiments, the molar ratio of the second soft segments to the first soft segments is about 2.0 or less. In various embodiments, the molar ratio of the second soft segments to the first soft segments is about 0.05, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, or 1.95.

It is noted that (α,ω)-terminated polymers are terminated at each end of the polymer. The α-termination may be the same or different than the ω-termination on the opposite end. The fluoropolymers and/or the polyesters or polyethers may terminated with a combination of hydroxyl groups, amine groups, and thiol groups, among other possible termination groups. Note that thiols can react with an —NCO group (usually catalyzed by tertiary amines) to generate a thiourethane.

Also it is noted that in this disclosure, “(α,ω)-termination” includes branching at the ends, so that the number of terminations may be greater than 2 per polymer molecule. The polymers herein may be linear or branched, and there may be various terminations and functional groups within the polymer chain, besides the end (α,ω) terminations.

In this description, “polyurethane” is a polymer comprising a chain of organic units joined by carbamate (urethane) links, where “urethane” refers to N(H)—(C═O)—O—. Polyurethanes are generally produced by reacting an isocyanate containing two or more isocyanate groups per molecule with one or more polyols containing on average two or more hydroxyl groups per molecule, in the presence of a catalyst.

Polyols are polymers with on average two or more hydroxyl groups per molecule. For example, α,ω-hydroxyl-terminated perfluoropolyether is a type of polyol.

“Isocyanate” is the functional group with the formula —N═C═O. For the purposes of this disclosure, O—C(═O)—N(H)—R is considered a derivative of isocyanate. “Isocyanate functionality” refers to the number of isocyanate reactive sites on a molecule. For example, diisocyanates have two isocyanate reactive sites and therefore an isocyanate functionality of 2. Triisocyanates have three isocyanate reactive sites and therefore an isocyanate functionality of 3. Exemplary isocyanates include Vestanat® 1890 and Desmodur® 3300.

“Polyfluoroether” refers to a class of polymers that contain an ether group—an oxygen atom connected to two alkyl or aryl groups, where at least one hydrogen atom is replaced by a fluorine atom in an alkyl or aryl group.

“Perfluoropolyether” (PFPE) is a highly fluorinated subset of polyfluoroethers, wherein all hydrogen atoms are replaced by fluorine atoms in the alkyl or aryl groups.

“Polyurea” is a polymer comprising a chain of organic units joined by urea links, where “urea” refers to N(H)—(C═O)—N(H)—. Polyureas are generally produced by reacting an isocyanate containing two or more isocyanate groups per molecule with one or more multifunctional amines (e.g., diamines) containing on average two or more amine groups per molecule, optionally in the presence of a catalyst.

A “chain extender or crosslinker” is a compound (or mixture of compounds) that link long molecules together and thereby complete a polymer reaction. Chain extenders or crosslinkers are also known as curing agents, curatives, or hardeners. In polyurethane/urea systems, a curative is typically comprised of hydroxyl-terminated or amine-terminated compounds which react with isocyanate groups present in the mixture. Diols as curatives form urethane linkages, while diamines as curatives form urea linkages. The choice of chain extender or crosslinker may be determined by end groups present on a given prepolymer. In the case of isocyanate end groups, curing can be accomplished through chain extension using multifunctional amines or alcohols, for example. Chain extenders or crosslinkers can have an average functionality greater than 2 (such as 2.5, 3.0, or greater), i.e. beyond diols or diamines.

In some embodiments, polyesters or polyethers are selected from the group consisting of poly(oxymethylene), poly(ethylene glycol), poly(propylene glycol), poly(tetrahydrofuran), poly(glycolic acid), poly(caprolactone), poly(ethylene adipate), poly(hydroxybutyrate), poly(hydroxyalkanoate), and combinations thereof.

In some embodiments, the isocyanate species is selected from the group consisting of 4,4′-methylenebis(cyclohexyl isocyanate), hexamethylene diisocyanate, cycloalkyl-based diisocyanates, tolylene-2,4-diisocyanate, 4,4′-methylenebis(phenyl isocyanate), isophorone diisocyanate, and combinations or derivatives thereof.

The polyol or polyamine chain extender or crosslinker possesses a functionality of 2 or greater, in some embodiments. At least one polyol or polyamine chain extender or crosslinker may be selected from the group consisting of 1,4-butanediol, 1,3-propanediol, 1,2-ethanediol, glycerol, trimethylolpropane, ethylenediamine, isophoronediamine, diaminocyclohexane, and homologues, derivatives, or combinations thereof. In some embodiments, polymeric forms of polyol chain extenders or crosslinkers are utilized, typically hydrocarbon or acrylic backbones with hydroxyl groups distributed along the side groups.

The one or more chain extenders or crosslinkers (or reaction products thereof) may be present in a concentration, in the segmented copolymer composition, from about 0.01 wt % to about 25 wt %, such as from about 0.05 wt % to about 10 wt %.

First soft segments may be present in a concentration from about 5 wt % to about 95 wt % based on total weight of the composition. In various embodiments, the first soft segments may be present in a concentration of about 5, 10, 20, 30, 40, 50, 60, 70, 80, 90, or 95 wt % based on total weight of the composition. Second soft segments may be present in a concentration from about 5 wt % to about 95 wt % based on total weight of the composition. In various embodiments, the second soft segments may be present in a concentration of about 5, 10, 20, 30, 40, 50, 60, 70, 80, 90, or 95 wt % based on total weight of the composition.

In some embodiments, fluorinated polyurethane oligomers are terminated with silane groups. The end groups on the oligomers (in the prepolymer) may be modified from isocyanate to silyl ethers. This can be accomplished through reaction of an isocyanate-reactive silane species (e.g., aminopropyltriethoxysilane) to provide hydrolysable groups well-known in silicon and siloxane chemistry. Such an approach eliminates the need for addition of a stoichiometric amount of curative to form strongly associative hard segments, while replacing the curative with species that possess the ability to form a covalently crosslinked network under the influence of moisture or heat. Such chemistry has been shown to preserve beneficial aspects of urethane coatings while boosting scratch resistance.

In addition, the reactivity of the terminal silane groups allows for additional functionality in the form of complimentary silanes blended with the prepolymer mixture. The silanes are able to condense into the hydrolysable network upon curing. This strategy allows for discrete domains of distinct composition. A specific embodiment relevant to anti-fouling involves the combination of fluoro-containing urethane prepolymer that is endcapped by silane reactive groups with additional alkyl silanes.

In some embodiments employing segmented copolymers, the microphase-separated microstructure containing the first and second soft segments may be characterized as an inhomogeneous microstructure. As intended in this patent application, “phase inhomogeneity,” “inhomogeneous microstructure,” and the like mean that a multiphase microstructure is present in which there are at least two discrete phases that are separated from each other. The two phases may be one discrete solid structural phase in a continuous solid phase, two co-continuous solid phases, or two discrete solid structural phases in a third continuous solid phase, for example. In some embodiments, the length scale of phase inhomogeneity refers to the average size (e.g., effective diameter) of discrete inclusions of one phase dispersed in a continuous phase. In some embodiments, the length scale of phase inhomogeneity refers to the average center-to-center distance between nearest-neighbor inclusions of the same phase.

The average length scale of phase inhomogeneity (which may also be referred to as an average phase-separation length) may generally be from about 0.1 microns to about 500 microns. In some embodiments, the average length scale of phase inhomogeneity is from about 0.5 microns to about 100 microns, such as about 1 micron to about 50 microns. In various embodiments, the average length scale of phase inhomogeneity is about 0.1, 0.2, 0.3, 0.4, 0.5, 0.6, 0.7, 0.8, 0.9, 1, 2, 3, 4, 5, 10, 15, 20, 25, 30, 35, 40, 45, 50, 60, 70, 80, 90, 100, 150, 200, 250, 300, 350, 400, 450, or 500 microns, including any intermediate values not explicitly recited, and ranges starting, ending, or encompassing such intermediate values. These are average values, noting that a portion of phase inhomogeneity may be present on a length scale less than 0.1 micron or greater than 500 microns (e.g., about 1000 microns), with the overall average falling in the range of 0.1-500 microns. Note that in this disclosure, “about 0.1 microns” is intended to encompass 0.05-0.149 microns (50-149 nanometers), i.e. ordinary rounding.

The antimicrobial structure may also be characterized by hierarchical phase separation. For example, when segmented copolymers are utilized, first soft segments and second soft segments—in addition to being microphase-separated—are typically nanophase-separated. As intended herein, two materials being “nanophase-separated” means that the two materials are separated from each other on a length scale from about 1 nanometer to about 100 nanometers. For example, the nanophase-separation length scale may be from about 10 nanometers to about 100 nanometers.

The nanophase separation between first solid material (or phase) and second solid material (or phase) may be caused by the presence of a third solid material (or phase) disposed between regions of the first and second solid materials. For example, in the case of first and second solid materials being soft segments of a segmented copolymer also with hard segments, the nanophase separation may be driven by intermolecular association of hydrogen-bonded, dense hard segments. In these cases, in some embodiments, the first soft segments and the hard segments are nanophase-separated on an average nanophase-separation length scale from about 10 nanometers to less than 100 nanometers. Alternatively, or additionally, the second soft segments and the hard segments may be nanophase-separated on an average nanophase-separation length scale from about 10 nanometers to less than 100 nanometers. The first and second soft segments themselves may also be nanophase-separated on an average nanophase-separation length scale from about 10 nanometers to less than 100 nanometers, i.e., the length scale of the individual polymer molecules.

The nanophase-separation length scale is hierarchically distinct from the microphase-separation length scale. With traditional phase separation in block copolymers, the blocks chemically segregate at the molecular level, resulting in regions of segregation on the length scale of the molecules, such as a nanophase-separation length scale from about 10 nanometers to about 100 nanometers. See Petrovic et al., “POLYURETHANE ELASTOMERS” Prog. Polym. Sci., Vol. 16, 695-836, 1991. The extreme difference of the two soft segments means that in the reaction pot the soft segments do not mix homogeneously and so create discrete region that are rich in fluoropolymer or rich in non-fluoropolymer (e.g., PEG) components, distinct from the molecular-level segregation. These emulsion droplets contain a large amount of polymer chains and are thus in the micron length-scale range. These length scales survive the curing process, so that the final material contains the microphase separation that was set-up from the emulsion, in addition to the molecular-level (nanoscale) segregation.

In some embodiments, therefore, the larger length scale of separation (0.1-500 microns) is driven by an emulsion process, which provides microphase separation that is in addition to classic molecular-level phase separation. Chen et al., “Structure and morphology of segmented polyurethanes: 2. Influence of reactant incompatibility” POLYMER, 1983, Vol. 24, pages 1333-1340, is hereby incorporated by reference herein for its teachings about microphase separation that can arise from an emulsion-based procedure.

In some embodiments, discrete inclusions have an average size (e.g., effective diameter) from about 50 nm to about 150 μm, such as from about 100 nm to about 100 μm. In various embodiments, discrete inclusions have an average size (e.g., effective diameter) of about 50 nm, 100 nm, 200 nm, 500 nm, 1 μm, 2 μm, 5 μm, 10 μm, 50 μm, 100 μm, or 200 μm.

In these or other embodiments, discrete inclusions (of discrete solid structural phase) have an average center-to-center spacing between adjacent inclusions, through a continuous matrix (of continuous transport phase), from about 50 nm to about 150 μm, such as from about 100 nm to about 100 μm. In various embodiments, discrete inclusions have an average center-to-center spacing between adjacent inclusions of about 50 nm, 100 nm, 200 nm, 500 nm, 1 μm, 2 μm, 5 μm, 10 μm, 50 μm, 100 μm, or 200 μm.

In some variations of the invention, the antimicrobial structure forms a coating disposed on a substrate. The coating may have a thickness from about 1 μm to about 10 mm, for example. In various embodiments, the coating thickness is about, at least about, or at most about 100 nm, 1 μm, 10 μm, 100 μm, 1 mm, or 10 mm, including any intervening ranges. Thicker coatings provide the benefit that even after surface abrasion, the coating still functions because the entire depth of the coating (not just the outer surface) contains the functional materials. The coating thickness will generally depend on the specific application. Note that the definition of optical transparency in this disclosure, which averages the transparency across light wavelengths from 400 nm to 800 nm through a 100-micron film of the antimicrobial structure at 25° C. and 1 bar, does not mean that the coating thickness must be 100 μm.

An optional substrate may be disposed on the back side of the antimicrobial structure. A substrate will be present when the material forms a coating or a portion of a coating (e.g., one layer of a multilayer coating). Many substrates are possible, such as a metal, polymer, wood, or glass substrate. Essentially, the substrate may be any material or object for which antimicrobial protection is desirable.

In some embodiments, an adhesion layer is disposed on a substrate, wherein the adhesion layer is configured to promote adhesion of the antimicrobial structure to the selected substrate. An adhesion layer contains one or more adhesion-promoting materials, such as (but not limited to) primers (e.g., carboxylated styrene-butadiene polymers), alkoxysilanes, zirconates, and titanium alkoxides.

Various strategies are possible to form the materials of the antimicrobial structure, as will be appreciated by a skilled artisan.

In some embodiments, the antimicrobial structure is in the form of an applique that may be adhered to a surface at the point of use.

Prior to formation of the final antimicrobial structure, a precursor composition may be provided. The precursor composition may be waterborne, solventborne, or a combination thereof. In some waterborne embodiments, first or second soft segments may be derived from an aqueous dispersion of a linear crosslinkable polyurethane containing charged groups, and the other soft segments may be derived from a crosslinking agent containing charged groups, for example.

In some embodiments, a precursor includes a silane, a silyl ether, a silanol, an alcohol, or a combination or reaction product thereof, and optionally further includes a protecting group that protects the precursor from reacting with other components.

Some embodiments employ waterborne polyurethane dispersions. A successful waterborne polyurethane dispersion sometimes requires the specific components to contain ionic groups to aid in stabilizing the emulsion. Other factors contributing to the formulation of a stable dispersion include the concentration of ionic groups, concentration of water or solvent, and rate of water addition and mixing during the inversion process. An isocyanate prepolymer may be dispersed in water. Subsequently, a curative component may be dispersed in water. Water evaporation then promotes the formation of a microphase-separated polyurethane material.

A composition or precursor composition may generally be formed from a precursor material (or combination of materials) that may be provided, obtained, or fabricated from starting components. The precursor material is capable of hardening or curing in some fashion, to form a precursor composition containing the first soft segments and second soft segments, microphase-separated on a microphase-separation length scale from about 0.1 microns to about 500 microns. The precursor material may be a liquid; a multiphase liquid; a multiphase slurry, emulsion, or suspension; a gel; or a dissolved solid (in solvent), for example.

In some embodiments, an emulsion sets up in the reaction mixture based on incompatibility between the two blocks (e.g., PEG and PC). The emulsion provides microphase separation in the precursor material. The precursor material is then cured from casting or spraying. The microphase separation survives the curing process (even if the length scales change somewhat during curing), providing the benefits in the final materials (or precursor compositions) as described herein. The microphase separation in this invention is not associated with molecular length-scale separation (5-50 nm) that many classic block-copolymer systems exhibit. Rather, the larger length scales of microphase separation, i.e. 0.1-500 μm, arise from the emulsion that was set-up prior to curing.

Xu et al., “Structure and morphology of segmented polyurethanes: 1. Influence of incompatibility on hard-segment sequence length” POLYMER, 1983, Vol. 24, pages 1327-1332 and Chen et al., “Structure and morphology of segmented polyurethanes: 2. Influence of reactant incompatibility” POLYMER, 1983, Vol. 24, pages 1333-1340, are each hereby incorporated by reference herein for their teachings about emulsion set-up in polyurethane systems prior to curing.

In some variations of the invention, a precursor material is applied to a substrate and allowed to react, cure, or harden to form a final composition (e.g., coating). In some embodiments, a precursor material is prepared and then dispensed (deposited) over an area of interest. Any known methods to deposit precursor materials may be employed. A fluid precursor material allows for convenient dispensing using spray coating or casting techniques.

The fluid precursor material may be applied to a surface using any coating technique, such as (but not limited to) spray coating, dip coating, doctor-blade coating, air knife coating, curtain coating, single and multilayer slide coating, gap coating, knife-over-roll coating, metering rod (Meyer bar) coating, reverse roll coating, rotary screen coating, extrusion coating, casting, or printing. Because relatively simple coating processes may be employed, rather than lithography or vacuum-based techniques, the fluid precursor material may be rapidly sprayed or cast in thin layers over large areas (such as multiple square meters).

When a solvent or carrier fluid is present in a fluid precursor material, the solvent or carrier fluid may include one or more compounds selected from the group consisting of water, alcohols (such as methanol, ethanol, isopropanol, or tert-butanol), ketones (such as acetone, methyl ethyl ketone, or methyl isobutyl ketone), hydrocarbons (e.g., toluene), acetates (such as tert-butyl acetate), acids (such as organic acids), bases, and any mixtures thereof. When a solvent or carrier fluid is present, it may be in a concentration of from about 10 wt % to about 99 wt % or higher, for example.

The precursor material may be converted to an intermediate material or the final composition using any one or more of curing or other chemical reactions, or separations such as removal of solvent or carrier fluid, monomer, water, or vapor. Curing refers to toughening or hardening of a polymeric material by physical crosslinking, covalent crosslinking, and/or covalent bonding of polymer chains, assisted by electromagnetic waves, electron beams, heat, and/or chemical additives. Chemical removal may be accomplished by heating/flashing, vacuum extraction, solvent extraction, centrifugation, etc. Physical transformations may also be involved to transfer precursor material into a mold, for example. Additives may be introduced during the hardening process, if desired, to adjust pH, stability, density, viscosity, color, or other properties, for functional, ornamental, safety, or other reasons.

In this detailed description, reference has been made to multiple embodiments and to the accompanying figures in which are shown by way of illustration specific exemplary embodiments of the invention. These embodiments are described in sufficient detail to enable those skilled in the art to practice the invention, and it is to be understood that modifications to the various disclosed embodiments may be made by a skilled artisan.

Where methods and steps described above indicate certain events occurring in certain order, those of ordinary skill in the art will recognize that the ordering of certain steps may be modified and that such modifications are in accordance with the variations of the invention. Additionally, certain steps may be performed concurrently in a parallel process when possible, as well as performed sequentially.

All publications, patents, and patent applications cited in this specification are herein incorporated by reference in their entirety as if each publication, patent, or patent application were specifically and individually put forth herein. This patent application hereby incorporates by reference the following patents: U.S. Pat. No. 10,689,542, issued on Jun. 23, 2020; U.S. Pat. No. 11,225,589, issued on Jan. 18, 2022; and U.S. Pat. No. 11,369,109, issued on Jun. 28, 2022.

The embodiments, variations, and figures described above should provide an indication of the utility and versatility of the present invention. Other embodiments that do not provide all of the features and advantages set forth herein may also be utilized, without departing from the spirit and scope of the present invention. Such modifications and variations are considered to be within the scope of the invention defined by the claims.

### EXAMPLES

### Example 1: Surface Indicator Test Pad for Quaternary Ammonium Halide Elution from an Antimicrobial Biphasic Coating

A biphasic coating consisting of 25 vol % poly(ethylene glycol) (PEG) transport phase, 20 vol % poly(tetrahydrofuran) (pTHF) structural phase, 5 vol % perfluoropolyether (PFPE), and 50 vol % urethane hard segment is cast onto TPO. TPO (Spartech, Maryland Heights, Missouri, USA) is a thermoplastic polyolefin made of polyethylene mixed with rubber particles and containing solid colorants.

The biphasic coating is soaked for 48 hr in a quat solution of 10 wt % quaternary ammonium chloride mixture (Bardac 208M, 80% actives, Lonza, LLC, Morristown, N.J., USA) in deionized water. The soaking fully saturates the PEG transport phase with the quat solution, forming an active biphasic antimicrobial coating. To partially reduce the quat level, the coated TPO sample is soaked for 1 hour in pure deionized water.

After soaking and padding dry, elution of the remaining quat is monitored using a modification of QAC QR Test Strips, code 2951, LaMotte (Chestertown, Md., USA). These commercial test strips are designed to measure quat concentrations from 50 ppm to 400 ppm in bulk aqueous solutions. To utilize the test strips as surface sensors to measure quat elution from the antimicrobial biphasic coating, the −5 mm×5 mm porous paper test square at the end of the plastic dip-stick is removed from the test strip. The test square is wet with deionized water and pressed lightly onto the biphasic coating.

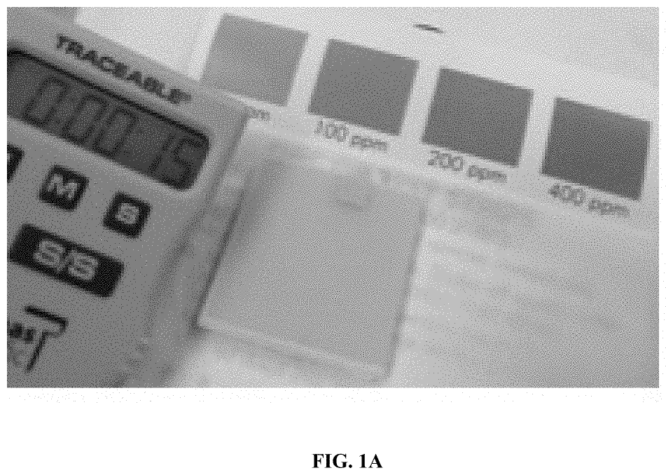

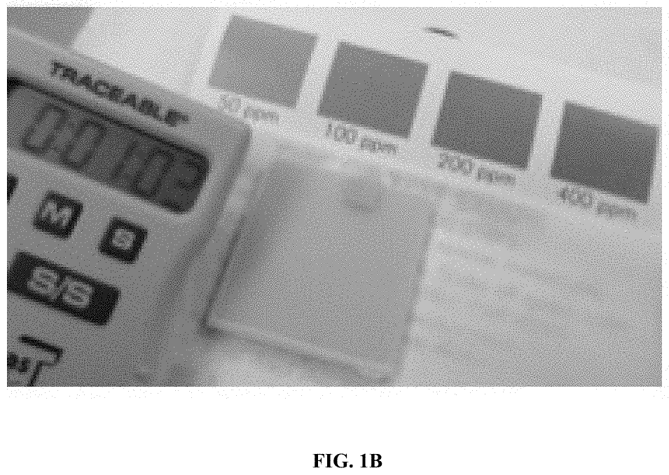

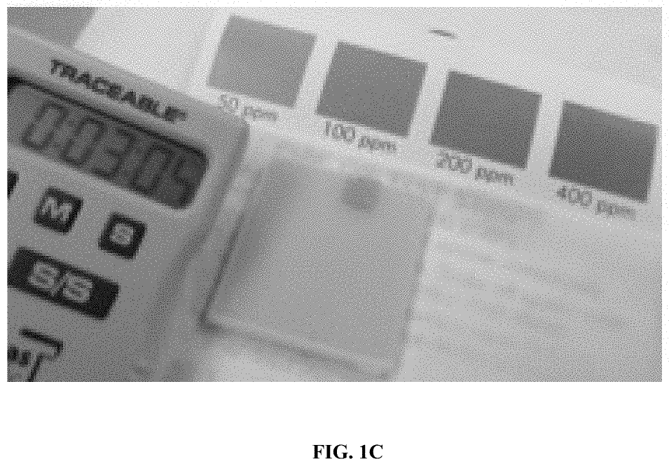

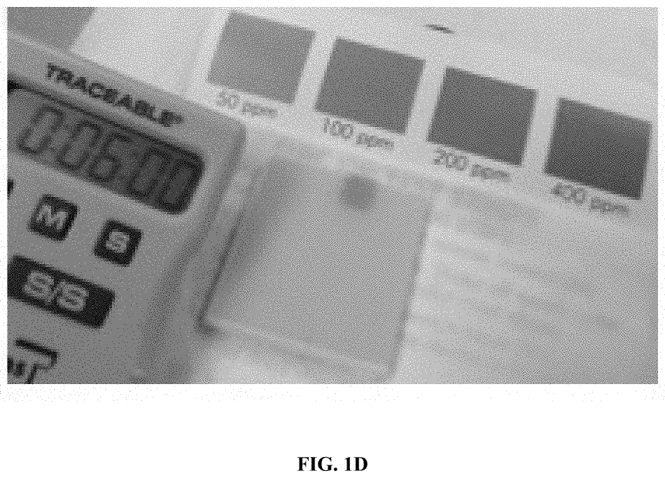

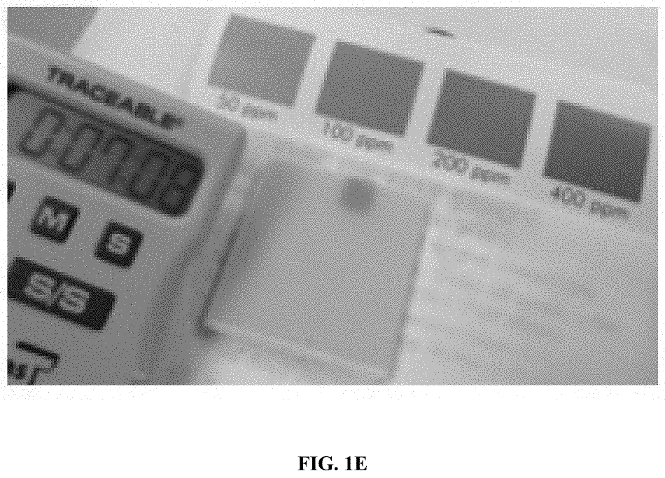

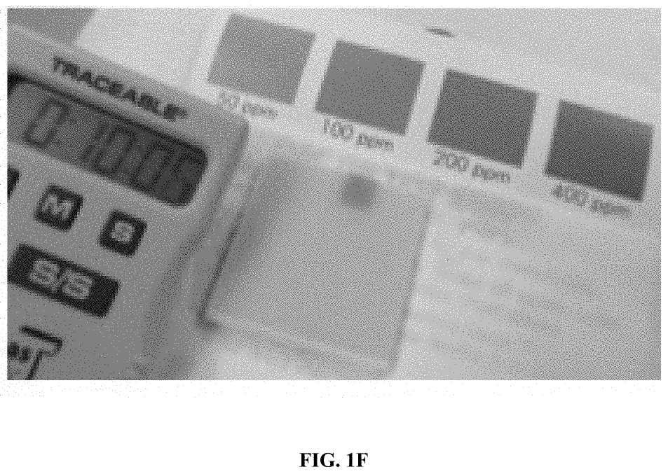

The color of the test square is monitored over 10 minutes and compared with the standard colors provided for concentrations of 50 ppm, 100 ppm, 200 ppm, and 400 ppm. FIGS. 1A to 1F (photographs) show the time evolution of the surface indicator test pad, revealing quaternary ammonium halide elution from the antimicrobial biphasic coating. Time is indicated by the digital clock on the left side of each image. In particular, FIG. 1A shows the surface indicator test pad after 15 seconds; FIG. 1B after 1 minute and 3 seconds; FIG. 1C after 3 minutes and 5 seconds; FIG. 1D after 6 minutes; FIG. 1E after 7 minutes and 8 seconds; and FIG. 1F after 10 minutes and 6 seconds.

As shown in FIG. 1A, after 15 sec, the color of the test pad indicates that the quat concentration of is less than 50 ppm. After about 1 min, the quat concentration is approximately 50 ppm (FIG. 1). After about 3 min, the quat concentration is approximately 100 ppm (FIG. 1C). After about 6-7 min, the quat concentration is approximately 200 ppm (FIGS. 1D and 1E). Finally, after about 10 min, the quat concentration is in the range 200 to 400 ppm (FIG. 1F). This example demonstrates that an appropriate test paper soaked with water and adhered to an antimicrobial biphasic coating with a transparent backing can be used to monitor the concentration of an antimicrobial active (in this case, quat) and its elution.

### Example 2: Surface Indicator Test Pad for Bleach Elution from an Antimicrobial Biphasic Coating

A biphasic coating consisting of 17 vol % poly(ethylene glycol) (PEG) transport phase, 33 vol % polycarbonate (PC) structural phase, and 50 vol % urethane hard segment is cast onto a Declam substrate. Declam (The Boeing Company, Chicago, Ill., USA) is a laminate with a poly(vinyl fluoride) top surface.

The biphasic coating is soaked for 70 hr in a solution of 0.1 wt % commercial bleach solution (Concentrated Disinfecting Bleach, 7.5 wt % sodium hypochlorite, Kroger Co., Cincinnati, Ohio, USA), diluted with deionized water. This soaking fully saturates the PEG transport phase with the bleach solution, forming an active antimicrobial biphasic coating.

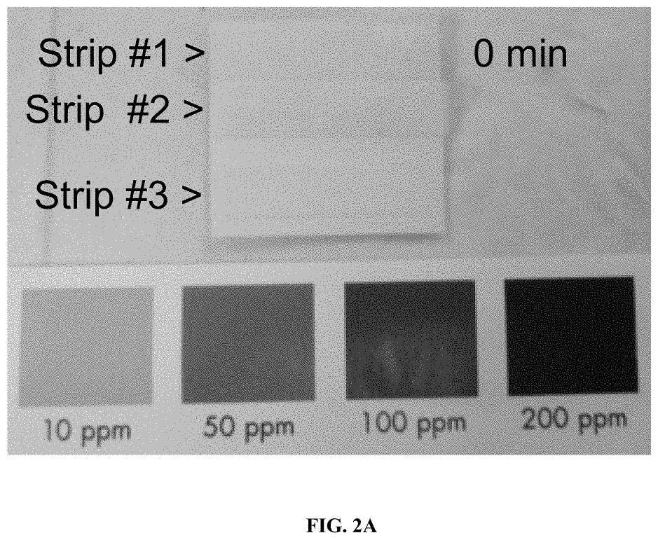

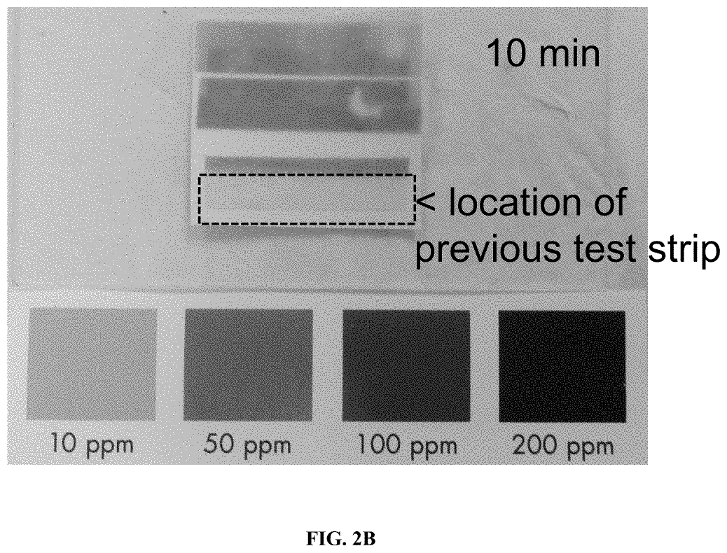

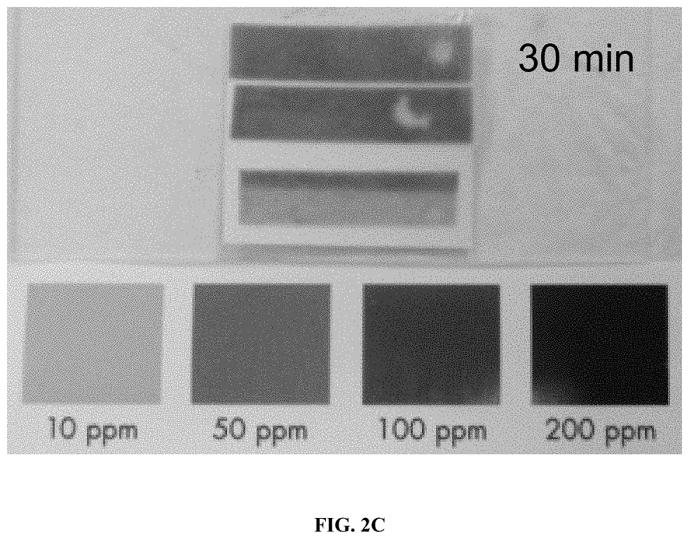

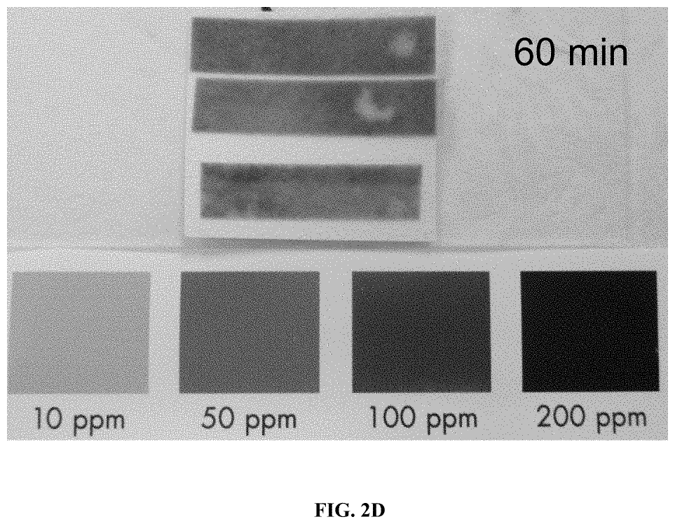

After soaking, the biphasic coating is rinsed for about 5 sec with deionized water and then allowed to sit for 26 hours at room temperature at 64% relative humidity. During sitting, the coating partially dries out, which may cause bleach decomposition. After sitting, elution of the remaining bleach from the coating is monitored using Total Chlorine Test Papers, code 4250-BJ, LaMotte (Chestertown, Md., USA). These commercial strips are ˜0.6 cm×8 cm porous paper strips designed to measure bleach concentrations from 10 ppm to 200 ppm in bulk aqueous solutions. To utilize the test strips as surface sensors to measure bleach elution from the coating, three ˜0.6 cm×˜3 cm strips (labeled #1, #2, and #3 in FIG. 2A) are wet with deionized water and laid over a ˜3 cm×˜3 cm test pad. The test pad is covered to keep the test strips wet.

The color of the strips is monitored over 1 hour and compared with the standard colors provided for bleach concentrations of 10 ppm, 50 ppm, 100 ppm, and 200 ppm. Photographs of the test pad with three strips (#1, #2, and #3) are shown in FIGS. 2A to 2D, for bleach elution from the antimicrobial biphasic coating. FIG. 2A shows the starting strips at 0 min. FIG. 2B shows the strips after 10 min of bleach elution. FIG. 2C shows the strips after 30 min of bleach elution. FIG. 2D shows the strips after 60 min of bleach elution. In all images, the sequence of the strips is not altered from FIG. 2A.

After 10 min, the color of the strips indicates a bleach concentration of about 50 ppm (FIG. 2B). Inhomogeneities in the bleach concentration are apparent. A circular mark on strip #1 (right side) and a crescent mark on strip #2 (right center) indicate areas with a bleach concentration less than 50 ppm. For strip #3, the lower two-thirds of the strip shows a bleach concentration less than 10 ppm. This region in strip #3 was previously tested and thereby partially depleted of bleach. After 30 min, the bleach concentration increases to about 100 ppm, and the lower two-thirds of strip #3 begins to fill in (FIG. 2C). After 60 min, the bleach concentration is in the 100-200 ppm range (FIG. 2D). This example demonstrates that a test paper soaked with water and adhered to an antimicrobial biphasic coating with a transparent backing can be used to monitor the concentration of an antimicrobial active (in this case, bleach) and its elution.

What is claimed is:

1. A sensing system configured to measure the concentration of an antimicrobial agent in a polymer, said system comprising:
(a) a polymer containing (i) a discrete solid structural phase comprising a solid structural polymer and (ii) a continuous transport phase comprising a solid transport polymer, wherein said continuous transport phase is capable of containing said antimicrobial agent; and
(b) an antimicrobial-agent sensor that chemically senses said antimicrobial agent, wherein said antimicrobial-agent sensor is disposed on a surface of, and in mass transport with, said polymer,
wherein said antimicrobial-agent sensor contains a responsive material disposed on or within a carrier material,
wherein said responsive material is chemically reactive with said antimicrobial agent, and
wherein said responsive material exhibits an observable and quantifiable property change upon chemically reacting with said antimicrobial agent.

2. The sensing system of claim 1, wherein said carrier material is a solid sheet.

3. The sensing system of claim 2, wherein said solid sheet is selected from the group consisting of a paper sheet, a plastic sheet, a metal or metal alloy sheet, a metal oxide sheet, a carbon sheet, and combinations thereof.

4. The sensing system of claim 2, wherein a side of said solid sheet is completely covered by said responsive material.

5. The sensing system of claim 2, wherein said solid sheet is at least partially coated with an adhesive to attach said antimicrobial-agent sensor to said polymer.

6. The sensing system of claim 2, wherein said solid sheet further contains a solvent selected from water, an organic solvent, or a combination thereof, and wherein said solvent optionally further contains an acid or a base.

7. The sensing system of claim 2, wherein an outer surface of said solid sheet is covered by an impermeable transparent or translucent layer.

8. The sensing system of claim 1, wherein said carrier material is a liquid selected from water, an organic solvent, or a combination thereof.

9. The sensing system of claim 8, wherein said organic solvent is selected from the group consisting of alcohols, sulfoxides, polyols, ketones, aldehydes, ethers, esters, and combinations thereof.

10. The sensing system of claim 8, wherein said liquid is thickened with a viscosity-modifying additive.

11. The sensing system of claim 1, wherein said observable and quantifiable property change is a change in chromaticity of said responsive material.

12. The sensing system of claim 1, wherein said observable and quantifiable property change is a change in optical transparency of said responsive material.

13. The sensing system of claim 1, wherein said observable and quantifiable property change is a change in ionic conductivity of said responsive material.

14. The sensing system of claim 1, wherein said observable and quantifiable property change is a change in electronic conductivity of said responsive material.

15. The sensing system of claim 1, wherein said solid structural polymer is selected from non-fluorinated carbon-based polymers.

16. The sensing system of claim 15, wherein said non-fluorinated carbon-based polymers are selected from the group consisting of polycarbonates, polyacrylates, polyalkanes, polyurethanes, polyethers, polyureas, polyesters, polyepoxides, and combinations thereof.

17. The sensing system of claim 1, wherein said solid structural polymer is selected from fluorinated polymers.

18. The sensing system of claim 17, wherein said fluorinated polymers are selected from the group consisting of fluorinated polyols, perfluorocarbons, perfluoropolyethers, polyfluoroacrylates, polyfluorosiloxanes, polyvinylidene fluoride, polytrifluoroethylene, and combinations thereof.

19. The sensing system of claim 17, wherein said fluorinated polymers are branched fluoropolymers with pendant reactive groups.

20. The sensing system of claim 1, wherein said solid transport polymer is a hygroscopic solid transport polymer selected from the group consisting of poly(acrylic acid), poly(ethylene glycol), poly(2-hydroxyethyl methacrylate), poly(vinyl imidazole), poly(2-methyl-2-oxazoline), poly(2-ethyl-2-oxazoline), poly(vinylpyrolidone), modified cellulosic polymers, carboxymethyl cellulose, hydroxyethyl cellulose, hydroxypropyl cellulose, methyl cellulose, and combinations thereof.

21. The sensing system of claim 1, wherein said solid transport polymer is a hydrophobic, non-lipophobic solid transport polymer selected from the group consisting of poly(propylene glycol), poly(tetramethylene glycol), polybutadiene, polycarbonate, polycaprolactone, acrylic polyols, and combinations thereof.

22. The sensing system of claim 1, wherein said solid transport polymer is a hydrophilic solid transport polymer with ionic charge, and wherein said ionic charge is optionally present within said hydrophilic solid transport polymer as carboxylate groups, amine groups, sulfate groups, or phosphate groups.

23. The sensing system of claim 1, wherein said solid transport polymer is an electrolyte solid transport polymer selected from the group consisting of polyethylene oxide, polypropylene oxide, polycarbonates, polysiloxanes, polyvinylidene difluoride, and combinations thereof.

24. The sensing system of claim 1, wherein said antimicrobial agent is selected from quaternary ammonium molecules.

25. The sensing system of claim 1, wherein said antimicrobial agent is selected from oxidizing molecules, and wherein said oxidizing molecules are optionally selected from the group consisting of hypochlorous acid, hydrogen peroxide, sodium hypochlorite, sodium chlorite, sodium chlorate, calcium hypochlorite, calcium chlorite, calcium chlorate, calcium perchlorate, and combinations thereof.
